(19) United States
(12) Patent Application Publication
(10) Pub. No.: US 2004/0049340 A1
(43) Pub. Date: Mar. 11, 2004

(54) Navigation device

(76) Inventor: Yoshimasa Usui, Nagoya-city (JP)

Correspondence Address: POSZ & BETHARDS, PLC, 11250 ROGER BACON DRIVE, SUITE 10, RESTON, VA, 20190, US

(21) Appl. No.: 10/653,265

(22) Filed: Sep. 3, 2003

(30) Foreign Application Priority Data
Sep. 5, 2002 (JP) 2002-259575

(51) Int. Cl. G01C 21/34

(52) U.S. Cl. 701/209; 701/208; 340/995.19

(57) ABSTRACT

Processing for showing entrances to expressways proceeds as follows. A user specifies an expressway and selects a display of entrance list. Then, all the entrances of the specified expressway, located within an L1 (km)-radius circle of a present position are extracted. Driving routes to the respective entrances are computed, and lengths of the respective driving routes are computed. Thereafter, the entrances are sorted in ascending order of the lengths of the respective driving routes, and an entrance list based on the result of this sorting is displayed on a display unit. In the entrance list, the entrances and lengths are listed in pairs in ascending order of the lengths. Further, after a format for storing the entrance is specified from among destination, way point, memory point, and point to be bypassed, processing is performed according to the specified format.

### CROSS REFERENCE TO RELATED APPLICATIONS

This application is based on and incorporates herein by reference Japanese Patent Application No. 2002-259575 filed on Sep. 5, 2002.

### FIELD OF THE INVENTION

The present invention relates to a navigation device and more particularly to a navigation device characterized in displaying of entrances and exits of roads that have fixed entrances and exits, such as expressways and toll roads.

### BACKGROUND OF THE INVENTION

As this type of apparatus, the navigation device disclosed in JP-A-H3-92714 is conventionally known. This navigation device disclosed in JP-A-H3-92714 is so constituted as to detect the present position of a vehicle, identify a point to be displayed closest to the present position, and display the name of the point. Therefore, with the navigation device disclosed in JP-A-H3-92714, an entrance or exit of an expressway can be displayed as the point closest to the present position of a vehicle. This is done by registering the entrances and exits of the expressway as points to be displayed.

However, the navigation device disclosed in JP-A-H3-92714 involves a problem. The problem is associated with the fact that the device does not discriminate between expressway and open road as point to be displayed. When the user driving on an expressway tries to search the nearest exit, points to be displayed on open roads near the expressway may be displayed. This problem is pronounced especially when an entrance of an expressway is searched. More specifically, where an entrance of an expressway is searched at a point distant from the expressway, there can be points to be displayed on many open roads between the present position and the expressway. Therefore, with the navigation device disclosed in JP-A-H3-92714, the entrance closest to the present position cannot be often displayed.

The navigation device disclosed in JP-A-H9-101161, known as a prior art, is provided with a displaying function. This function is to display the name of the interchange closest to the present position on an expressway and the distance thereto when an exit is searched during driving on the expressway. To carry out this function, the navigation device disclosed in JP-A-H9-101161 is provided with another function. This function is to exclude points to be displayed on open roads from targets to be searched during driving on an expressway.

However, this navigation device disclosed in JP-A-H9-101161 also involves a problem. The above-mentioned excluding function does not work during driving on an open road. Therefore, the above-mentioned problem associated with occasions where an entrance to an expressway is searched on an open road remains unsolved. That is, the navigation device disclosed in JP-A-H9-101161 cannot meet users' demand to search an entrance to an expressway on which the user is going to drive. Further, the navigation device disclosed in JP-A-H9-101161 only displays the name of the interchange closest to the present position on an expressway. Therefore, the device cannot cope with cases where the user driving on an expressway desires to know how many interchanges are present between the present position and the exit which the user is going to use.

The navigation device disclosed in JP-A-H9-96541, known as a prior art, is provided with another function. This function is to, if there is an expressway in shown routes, carry out computation and display the name of an interchange at which the user should exit from the expressway and the distance to the interchange.

However, this navigation device disclosed in JP-A-H9-96541 involves a problem as well. The device cannot cope with cases where the user driving on an expressway desires to know how many interchanges are present before the user arrives at an exit. Further, the navigation device disclosed in JP-A-H9-96541 is not provided with a function to meet users' desire to search entrances to an expressway on which the user is going to drive. More specifically, where a place of departure and a destination are fixed, this navigation device disclosed in JP-A-H9-96541 is capable of displaying exits of an expressway in shown routes between the place of departure and the destination. However, where the user desires to drive on an expressway without fixing any destination, the device cannot show the user entrances to the expressway.

The navigation device disclosed in JP-A-H7-49654, known as a prior art, is provided with another function. The function is to store spot data representing the positions and names of interchanges on expressways. Further, the function is to, when a vehicle is driving on an expressway, search interchanges present in the traveling direction and display the names of the interchanges in ascending order of the distances to the present position. With this navigation device disclosed in JP-A-H7-49654, the user driving on an expressway can easily know how many interchanges are present before the interchange at which the user should exit from the expressway. Thus, the user can drive the car without paying attention to interchange signs above the road.

This navigation device disclosed in JP-A-H7-49654 is provided with a further function for navigation in cases where the user drives from open roads to a desired destination by way of an expressway. This function is to show routes which connect the present point on an open road, an entrance to an expressway, an exit from the expressway, and a destination.

However, the navigation device disclosed in JP-A-H7-49654 is so designed as to display the exit closest to the present position when a destination is fixed. Therefore, the device cannot cope with cases where the user desires to drive on an expressway without fixing any destination for the time being and search the entrance closest to the present position. Further, the navigation device disclosed in JP-A-H7-49654 is so constituted as to carry out the display of entrances in relation with shown routes. Therefore, the device cannot display a plurality of entrances to the expressway concerned in ascending order of the distances to the present position. This cannot fulfill the above-mentioned drivers' intention only to drive on expressways. Therefore, the device cannot cope with, especially, cases where the user selects the entrance next closer to the present position, not the closest entrance depending on whether the user drives on the expressway in the up direction or in the down direction.

With conventional navigation devices, entrances and exits of an expressway can be searched by name without fixing any destination. In this case, a driver can use a method by which the driver makes the list of the names of the interchanges on the expressway appear on a display and selects the name of an interchange which the user is going to use. However, since a list of interchange names shows interchanges in an appellative sequence (e.g., alphabetical sequence), users can use this function only when the users know the names of entrances or exits.

As mentioned above, with prior arts, the following can be carried out:

(1) Displaying the names of exit interchanges in ascending order of the distances to the present position on an expressway during driving on the expressway,

(2) Displaying entrance interchanges when the expressway is included in shown routes with respect to a routing assisting function, and

(3) Listing the exits of an expressway in an appellative sequence (e.g., alphabetical sequence).

However, the following cannot be implemented:

(A) Displaying the name of the interchange located closest to the present position or a position specified by the user on an open road without fixing any destination before entering the expressway, especially

(B) Displaying interchanges as entrances to an expressway in ascending order of the distances from the present position, and

(C) Meeting users' desire to select an entrance for using an expressway in order to drive on the expressway.

Therefore, the conventional navigation devices are insufficient in a function of showing the interchanges of an expressway to a user who desires to drive on the expressway without expressly fixing any destination.

### SUMMARY OF THE INVENTION

It is an object of the present invention to enable a user to select with ease entrances or exits of a road that has fixed entrances and exits, such as an expressway and a toll road (hereafter, referred to as “road with entrances and exits”).

To achieve the above object, a navigation device is provided with the following. A display unit, an input unit, and a control unit are provided for displaying inputted map data that contain information on roads with entrances and exits. After a road with entrances and exits is specified by a user, a search reference position is determined. Entrances or exits of the road are thereby sorted and listed in a sequence on a basis of the search reference position in the display unit.

For patterns for this sorting on the basis of a search reference position, various bases can be established. Possible bases include, for example, ascending order of linear distances from a search reference position; ascending order of lengths of driving routes from a search reference position; ascending order of estimated driving times from a search reference position; descending order of numbers of beauty spots in driving routes from a search reference position; descending order of degrees of simplicity of routes; and ascending order of numbers of intersections.

The present invention may be constituted with only one of these bases for sorting provided. Or, the present invention may be constituted with a plurality of bases provided so that the user can select a basis for sorting. The present invention can be constituted so as to meet the user's desire to, for example, sort the entrances or exits in ascending order of driving times or in descending order of numbers of places of interest.

The navigation device of the present invention is capable of sorting entrances or exits on which the user is going to drive in a sequence on the basis of a search reference position. Moreover, the navigation device is capable of listing the sorted entrances or exits. Thus, the user can easily find which entrance or exit the user should use.

In drive routing assistance implemented with ordinary navigation devices as well, computation to find the entrance closest to the present position is carried out. However, this computation cannot be done unless a destination is fixed. By contrast, in the present invention, a road with entrances and exits can be specified, a search reference position can be determined, and the entrance list can be displayed. Thus, unlike ordinary navigation devices, the present invention can present entrances to an expressway to a user when the user desires only to drive down the expressway without fixing any destination. Furthermore, this presentation is made in the form of list so that the user can select an entrance with ease. The present invention is completely different from prior arts in that.

Furthermore, with this structure, a user driving down an open road can specify a road with entrances and exits on which the user is going to drive and can in advance check exits from the road with entrances and exits. Further, the navigation device of the present invention is provided with another function associated with the generation of exit lists. To carry out this function, a search reference position can be determined. Thus, an exit list can be generated with a position other than the present position, for example, a destination the user desires to drive to after getting off an expressway, taken as the search reference position. In this case, driving routes are shown in the direction opposite to the traveling direction. As mentioned above, the navigation device of the present invention not only provides a vehicle driving on an expressway with information on interchanges which will be encountered in the traveling direction. Also, the navigation device is capable of presenting exit lists meeting the user's varied demands when the user specifies a road to be searched.

### BRIEF DESCRIPTION OF THE DRAWINGS

The above and other objects, features, and advantages of the present invention will become more apparent from the following detailed description made with reference to the accompanying drawings of FIGS. 1 to 42.

FIG. 1 is a block diagram illustrating the constitution of the navigation device in the first embodiment.

FIG. 2 is a flowchart illustrating the details of the processing for showing the entrances and exits of an expressway in the first embodiment.

FIG. 3 is a flowchart illustrating the details of the processing for showing the entrances and exits of an expressway in the first embodiment.

FIG. 4 is a flowchart illustrating the details of the processing for showing the entrances and exits of an expressway in the first embodiment.

FIG. 5 is an explanatory drawing illustrating an example of the display image of an expressway entrance list in the first embodiment.

FIG. 6 is a flowchart illustrating the details of the processing for showing the entrances and exits of an expressway in the second embodiment.

FIG. 7 is a flowchart illustrating the details of the processing for showing the entrances and exits of an expressway in the second embodiment.

FIG. 8 is a flowchart illustrating the details of the processing for showing the entrances and exits of an expressway in the second embodiment.

FIG. 9 is an explanatory drawing illustrating an example of the display image of an expressway entrance list in the second embodiment.

FIG. 10 is an explanatory drawing illustrating an example of the display image of an expressway entrance list in the second embodiment.

FIG. 11 is a flowchart illustrating the details of the processing for showing the entrances and exits of an expressway in the third embodiment.

FIG. 12 is a flowchart illustrating the details of the processing for showing the entrances and exits of an expressway in the third embodiment.

FIG. 13 is a flowchart illustrating the details of the processing for showing the entrances and exits of an expressway in the third embodiment.

FIG. 14 is a flowchart illustrating the details of the processing for showing the entrances and exits of an expressway in the third embodiment.

FIG. 15 is a flowchart illustrating the details of the processing for showing the entrances and exits of an expressway in the third embodiment.

FIG. 16 is a flowchart illustrating the details of the processing for showing the entrances and exits of an expressway in the third embodiment.

FIG. 17 is a flowchart illustrating the details of the processing for showing the entrances and exits of an expressway in the third embodiment.

FIG. 18 is a flowchart illustrating the details of the processing for showing the entrances and exits of an expressway in the fourth embodiment.

FIG. 19 is a flowchart illustrating the details of the processing for showing the entrances and exits of an expressway in the fourth embodiment.

FIG. 20 is a flowchart illustrating the details of the processing for showing the entrances and exits of an expressway in the fourth embodiment.

FIG. 21 is a flowchart illustrating the details of the processing for showing the entrances and exits of an expressway in the fifth embodiment.

FIG. 22 is a flowchart illustrating the details of the processing for showing the entrances and exits of an expressway in the fifth embodiment.

FIG. 23 is a flowchart illustrating the details of the processing for showing the entrances and exits of an expressway in the fifth embodiment.

FIG. 24 is a flowchart illustrating the details of the processing for showing the entrances and exits of an expressway in the fifth embodiment.

FIG. 25 is a flowchart illustrating the details of the processing for showing the entrances and exits of an expressway in the fifth embodiment.

FIG. 26 is a flowchart illustrating the details of the processing for showing the entrances and exits of an expressway in the fifth embodiment.

FIG. 27 is a flowchart illustrating the details of the processing for showing the entrances and exits of an expressway in the fifth embodiment.

FIG. 28 is a flowchart illustrating the details of the processing for showing the entrances and exits of an expressway in the fifth embodiment.

FIG. 29 is a flowchart illustrating the details of the processing for showing the entrances and exits of an expressway in the fifth embodiment.

FIG. 30 is a flowchart illustrating the details of the processing for showing the entrances and exits of an expressway in the fifth embodiment.

FIG. 31 is an explanatory drawing illustrating an example of the display image of an expressway entrance list in the fifth embodiment.

FIG. 32 is an explanatory drawing illustrating an example of the display image of an expressway entrance list in the fifth embodiment.

FIG. 33 is a flowchart illustrating the details of the processing for showing the entrances and exits of an expressway in the sixth embodiment.

FIG. 34 is a flowchart illustrating the details of the processing for showing the entrances and exits of an expressway in the sixth embodiment.

FIG. 35 is a flowchart illustrating the details of the processing for showing the entrances and exits of an expressway in the sixth embodiment.

FIG. 36 is a flowchart illustrating the details of the processing for showing the entrances and exits of an expressway in the sixth embodiment.

FIG. 37 is a flowchart illustrating the details of the processing for showing the entrances and exits of an expressway in the sixth embodiment.

FIG. 38 is a flowchart illustrating the details of the processing for showing the entrances and exits of an expressway in the sixth embodiment.

FIG. 39 is a flowchart illustrating the details of the processing for showing the entrances and exits of an expressway in the sixth embodiment.

FIG. 40 is a flowchart illustrating the details of the processing for showing the entrances and exits of an expressway in the sixth embodiment.

FIG. 41 is a flowchart illustrating the details of the processing for showing the entrances and exits of an expressway in the sixth embodiment.

FIG. 42 is a flowchart illustrating the details of the processing for showing the entrances and exits of an expressway in the sixth embodiment.

### DETAILED DESCRIPTION OF THE PREFERRED EMBODIMENTS

(First Embodiment)

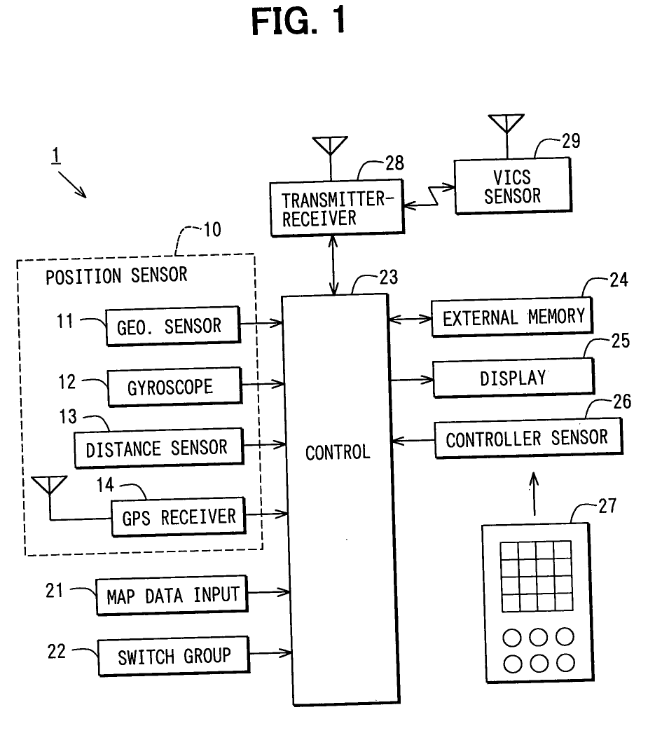

A first embodiment of the present invention will be described in connection with drawings. FIG. 1 is a block diagram schematically illustrating the constitution of the navigation device in the embodiment. As illustrated in the figure, the navigation device 1 includes a position sensor 10, a map data input unit 21, an operating switch group 22, a control unit 23, an external memory 24, a display unit 25, a remote controller sensor 26, a remote controller 27, a transmitter-receiver 28, and a VICS sensor 29.

The position sensor 10 includes a geomagnetism sensor 11, a gyroscope 12, a distance sensor 13, and a GPS receiver 14. The position sensor 10 receives radio waves from a GPS (Global Positioning System) satellite at the GPS receiver 14 and thereby detects latitude and longitude. Further, the position sensor 10 corrects the latitude and longitude acquired from the GPS satellite with data detected by the geomagnetism sensor 11 and the like. Thus, the position sensor 10 detects the present position by latitude and longitude. The map data input unit 21 is for setting a recording medium, such as DVD and CD-ROM, with road map data recorded thereon. On recording media set in the map data input unit 21, data related to the names of expressways, the nodes and links constituting the expressways, and the names and positions of the entrances and exits of the expressways is also recorded.

The operating switch group 22 includes switches for performing various operations, including changing of the displayed map images, instructing to expand or contract or scroll displayed images, and inputting destinations for route computation. The operating switch group 22 may be constituted of mechanical switches or touch panel switches integrated with the display unit 25.

The control unit 23 is constituted as an ordinary computer with CPU, ROM, RAM, I/O ports, and the like built therein. The control unit 23 executes computer programs installed in the ROM or the external memory 24, and thereby performs various types of processing. Such processing includes varied processing executed by ordinary car navigation devices, such as the display of maps, route computation, and routing assistance based on the results of route computation. It also includes processing for displaying lists of entrances and exits of expressways, which is one of the features of the embodiments of the present invention.

The external memory 24 is composed of a hard disk drive. The external memory 24 is used to enhance the operationality and functionality of the navigation device. For example, the external memory 24 stores map data and the like displayed on the display unit 25. Thus, when a map is displayed again, it is unnecessary to start up the map data input unit 21 to repeat read operation. The external memory 24 is also used to store computer programs, varied data, and like required for processing performed by the control unit 23.

The display unit 25 is a color liquid crystal display unit. On the screen of this display unit 25, information related to operation performed in ordinary car navigation devices is displayed. Such information includes a mark corresponding to the present position of the vehicle concerned, maps, marks for destinations specified by the user, routes to destinations computed based on the user's specifications, and the like. The display unit 25 also displays lists of entrances and exits of expressways, which is one of the features of this embodiment.

The remote controller 27 is for inputting information, similar to information inputted through the operating switch group 22, by remote control. Therefore, when a user operates the navigation device 1 in this embodiment, the user can input information through the remote controller 27, instead of the operating switch group 22. The remote controller sensor 26 is a sensor for detecting information inputted through the remote controller 27 and inputting the information to the control unit 23.

The transmitter-receiver 28 and the VICS sensor 29 are for conducting communication with VICS (Vehicle Information & Communication System). With the transmitter-receiver 28 and the VICS sensor 29, information on traffic jams and road construction can be acquired and the information can be used in route computation.

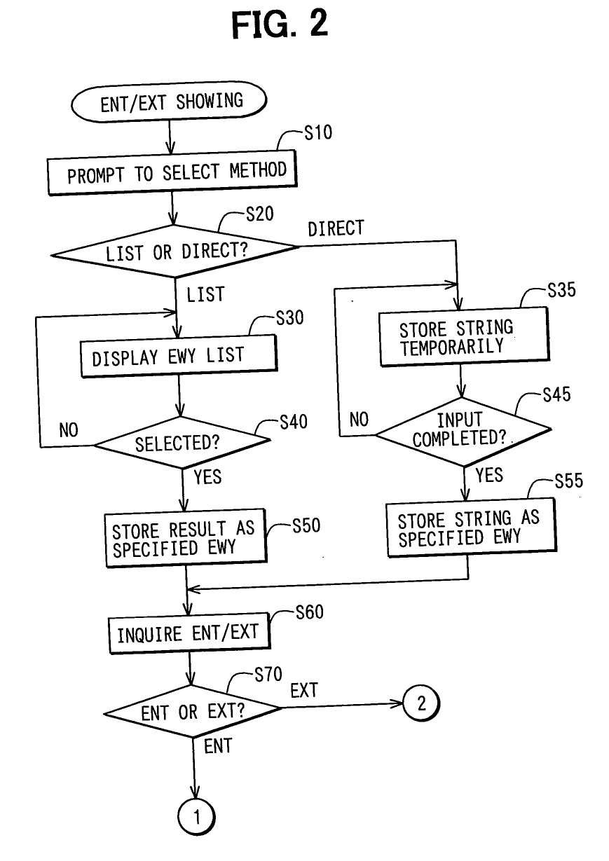

Next, referring to the flowcharts in FIG. 2 to FIG. 4, the details of processing for showing entrances (ENT) and exits (EXT) of an expressway (EWY), performed by the control unit 22 in this navigation device 1, will be described. This processing is initiated when the user inputs an actuation signal through the operating switch group 22 or the remote controller 27.

As illustrated in FIG. 2, when the processing for showing the entrances and exits of the expressway is initiated, a message is displayed on the display unit 25 (S10). This message is for prompting the user who is going to drive down an expressway to select a method for specifying the expressway. The expressway can be specified by either of two methods: (1) Selecting it from an expressway list and (2) Directly inputting the name of the expressway. The user operates the operating switch group 22 or the remote controller 27 and specifies that the user will select one from a list (S20: Selection from list). When that is detected, the expressway name list in which the names of expressways are listed in an appellative sequence (e.g., alphabetical sequence) is displayed on the display unit 25 (S30).

Then, the user operates the operating switch group 22 or the remote controller 27 to select one from the expressway list. When that is detected (S40: YES), the result of this selection is stored as the specified expressway in the RAM (S50). Alternatively, the user may operate the operating switch group 22 or the remote controller 27 to specify that the user will directly input an expressway name. When that is detected (S20: Direct input), a character string inputted through the operating switch group 22 or the remote controller 27 is temporarily stored in the RAM (S35). Thereafter, it is detected that a signal indicating the completion of input has been inputted through the operating switch group 22 or the remote controller 27 (S45: YES). Then, the expressway specified by the user (specified expressway) is identified based on the character string temporarily stored in the RAM, and the identified expressway is stored in the RAM (S55).

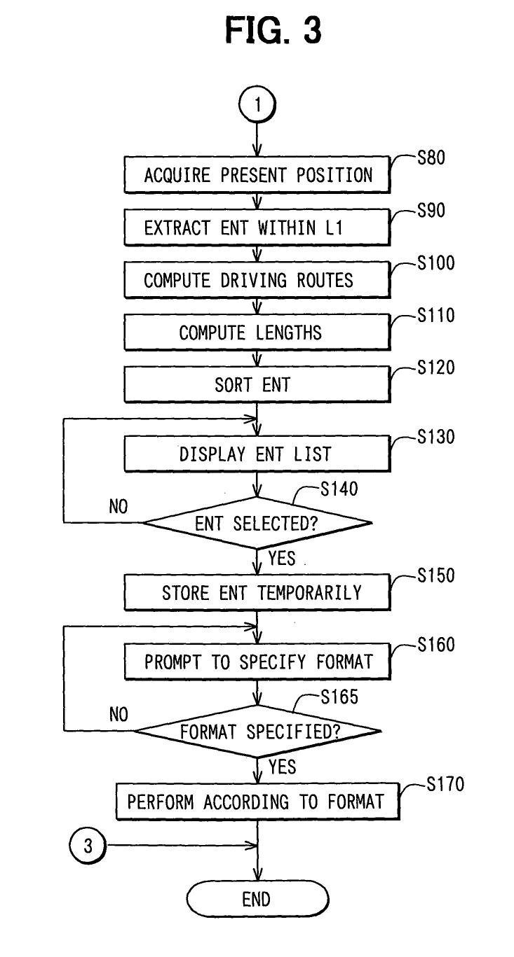

Thus, the specified expressway whose entrance/exit list should be displayed is determined. Then, a message inquiring whether to display entrances or exits is displayed on the display unit 25 (S60). The user operates the operating switch group 22 or the remote controller 27 to select “entrances” (S70: Entrances). When that is detected, the present position detected by the position sensor 10 is acquired, as illustrated in FIG. 3 (S80). Consequently, the entrances of the specified expressway, located within a circle with a radius of L1 (km) with the present position at the center are all extracted (S90).

Subsequently, driving routes with the present position acquired at S80 taken as the point of departure and the entrances extracted at S90 taken as objective points are computed (S100). Here, the driving routes are computed by the same technique as in route computation in ordinary routing assistance processing. At this time, information on traffic jams and road construction acquired through the transmitter-receiver 28 and the VICS sensor 29 is also taken into account. Therefore, driving routes from the present position to the individual entrances are computed so that the user can drive from the present position to the individual entrances in the shortest time. Thereafter, the lengths of the individual driving routes (distances to drive) are computed (S110).

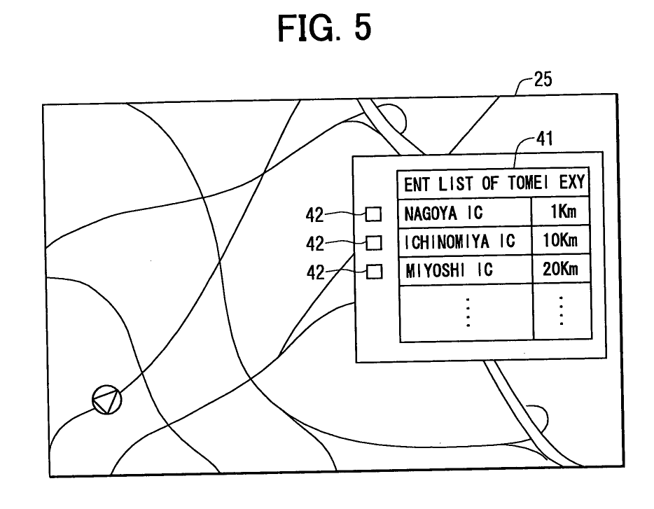

Thus, the driving routes and the distances to drive to a plurality of the entrances are computed. Then, the entrances extracted at S90 are sorted in ascending order of the distances to drive (S120). An entrance list based on the result of this sorting is displayed on the display unit 25 (S130). In the entrance list, the entrances extracted at S90 and the distances to drive computed at S110 are listed in pairs in ascending order of the distances to drive. FIG. 5 illustrates an example of the displayed entrance list. In case of the example in the figure, an entrance list 41 in which entrances of Tomei Expressway are listed is displayed. In this entrance list, the interchanges (IC) (Nagoya interchange, Ichinomiya interchange, Miyoshi interchange, . . . ) are listed in ascending order of the distances to drive to get there from the present position. It can be seen from this example that the entrance list 41 displays the names of the entrances in a sequence different from the actual sequence of the entrances of the expressway. If the interchanges are listed in the actual sequence of the entrances of Tomei Expressway, the interchange names must be listed in the order of . . . , Ichinomiya interchange, . . . , Nagoya interchange, Miyoshi interchanges . . . . As mentioned above, one of the features of the navigation device 1 in this embodiment is that interchanges of an expressway are not listed in the actual sequence thereof.

After the completion of the display of the entrance list, the operation waits until any entrance is selected through the operating switch group 22 or the remote controller 27 (S140). The user can select an entrance by checking an appropriate field 42 for selection, illustrated in FIG. 5. When it is detected that an entrance has been selected (S140: YES), the selected entrance is temporarily stored in the RAM (S150). Further, a message prompting to specify a format in which the entrance should be stored is displayed on the display unit 25 (S160). The operation waits until a storing format is specified (S165), and then, processing is performed according to the specified storing format (S170).

At this time, the storing formats the user can specify includes: (1) destination, (2) way point, (3) memory point, and (4) point to be bypassed. If an entrance selected by the user is specified as (1) destination, routing assistance is implemented with the driving routes computed at S100 taken as shown routes. If an entrance selected by the user is specified as (2) way point, the user is prompted to input a destination, and the quickest route for driving from the present point to the way point to the specified expressway to the destination is computed. Then, routing assistance is implemented based on the result of this computation. If an entrance selected by the user is specified as (3) memory point, the entrance temporarily stored in the RAM at S150 is re-stored in the memory point storage area in the external memory 24. This memory point can be read out of the external memory 24 according to a search term, such as name, in specifying a destination or a way point when drive route assistance is thereafter implemented. If an entrance selected by the user is specified as (4) point to be bypassed, the entrance selected at S140 is stored in the point to be bypassed storage area in the external memory 24. This point to be bypassed is used as a point which should not be used as a way point when drive route assistance is thereafter implemented.

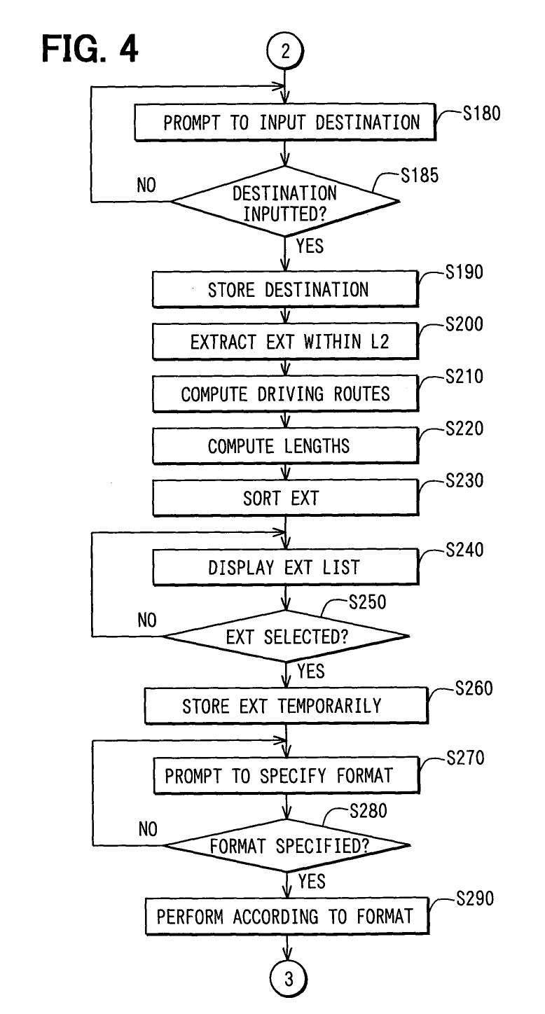

Alternatively, the user may operate the operating switch group 22 or the remote controller 27 to select “exits.” When it is detected that “exits” has been selected (S70: Exits), a message prompting to input a destination is displayed on the display unit 25, as illustrated in FIG. 4 (S180). As in inputting a destination for carrying out ordinary drive routing assistance function, the user can input a destination by facility name, facility phone number, municipality name, unique location code, or the like.

Unique location code is based on a position specifying method previously proposed by the applicant of the present application. According to this method, a map is divided into predetermined small squares, and a location code unique to each square is assigned thereto. Then, the location code and the latitude and longitude information of the corresponding square are correlated with each other. Thus, a facility, beauty spot, or the like concerned is identified by code based on the correlation between the latitude and longitude of the facility, beauty spot, or the like and the latitude and longitude information of the square identified by unique location code. There are several advantages of the unique location code. For example, a beauty spot which cannot be identified by phone number can be identified by code. Information on facilities and beauty spots can be added, modified, and deleted with ease.

When it is detected that a destination has been inputted (S185: YES), the destination is stored in the RAM (S190). Further, the exits of the specified expressway, located within a circle with a radius of L2 (km) with the destination at the center are all extracted (S200). The identical value may be set for L2 and L1, or different values may be set.

Thus, some exits in proximity to the destination are extracted from the exits of the specified expressway. Then, driving routes with the individual exits taken as points of departure and the destination taken as objective point are computed (S210). This driving route computation is the same as ordinary route computation. At this time, information on traffic jams and road construction received through the transmitter-receiver 28 and the VICS sensor 29 is also taken into account. Therefore, driving routes are computed so that the user can drive from the individual exits to the destination in the shortest time. Subsequently, the lengths of the individual driving routes (distances to drive) are computed (S220).

Thus, the driving routes and the distances to drive from a plurality of the exits to the destination are computed. Then, the exits extracted at S200 are sorted in ascending order of the distances to drive (S230). An exit list based on the result of this sorting is displayed on the display unit 25 (S240). In the exit list, the exits extracted at S200 and the distances to drive computed at S220 are listed in pairs in ascending order of the distances to drive.

After the completion of the display of the exit list, the operation waits until any exit is selected through the operating switch group 22 or the remote controller 27 (S250). The user can select an exit by checking a field for selection next to the name of each exit in the exit list as in cases where the entrance list 41 is displayed. When it is detected that an exit has been selected (S250: YES), the selected exit is temporarily stored in the RAM (S260). Further, a message prompting to specify a format in which the exit should be stored is displayed on the display unit 25 (S270). The operation waits until a storing format is specified, and then, processing is performed according to the specified storing format (S280, S290).

At this time as well, the user can specify one of several formats for storing the exit temporarily stored at S260: (1) destination, (2) way point, (3) memory point, and (4) point to be bypassed. If an exit selected by the user is specified as (1) destination, the present position is acquired from the position sensor 10. Then, the quickest route with the present position taken as point of departure and the selected exit taken as destination is computed. At this time, inclusion of the specified expressway in the driving routes is a prerequisite for computation. If the present position is out of the specified expressway, one of the entrances of the specified expressway through which the user can take the quickest driving route is adopted as a way point in the driving route from the present position to the destination. If the present position is on the specified expressway, a route on the specified expressway which connects the present position with the exit is simply computed as the driving route. If an exit selected by the user is specified as (2) way point, a driving route for driving from the present position to the selected exit to the destination stored at S190 in the shortest time is computed and routing assistance is implemented. At this time, inclusion of the specified expressway in the driving route is a prerequisite for computation. If the present position is out of the specified expressway, one of the entrances of the specified expressway through which the user can take the quickest driving route is adopted as a way point in the driving route from the present position to the destination. If the present position is on the specified expressway, a route on the expressway which connects the present position with the exit and the driving route computed at S210 are simply interlinked with each other. Thus, a driving route for routing assistance is computed. If an exit selected by the user is specified as (3) memory point or (4) point to be bypassed, the same processing as in cases where an entrance is specified as a memory point or a point to be bypassed is performed.

As described above, with this embodiment, a user can display an entrance list on the display unit 25 by specifying an expressway. In the entrance list, entrances to the expressway are listed in ascending order of the distances to drive to get there from the present position. Therefore, the user can be presented with an entrance list in ascending order of the distances to drive to get there from the present position without fixing any destination. To do this, the user only has to specify an expressway on which the user desires to drive. As a result, the user can select an entrance to the expressway referring to the entrance list. The entrance selected by the user can be specified as destination, way point, memory point, or point to be bypassed for routing assistance. Therefore, the user can be easily shown the way to an expressway on which the user has never driven before.

Further, according to this embodiment, a user who is going to drive down an expressway to a destination can be presented with required information in the form of exit list by specifying (1) “expressway” and (2) “destination.” In the exit list, exits available to the user are listed in ascending order of the distances to drive from the exits to the destination. Therefore, when an user plans a trip using an expressway, the user can obtain useful information for selecting an appropriate exit. This function is convenient to, for example, cases where an user accidentally drives by an optimum exit to a destination because of the user's unacquaintance with the place and desires to select the suboptimum exit. This is advantageous especially to driving on loop expressways, such as expressways in the capital. If a user accidentally drives by an exit through which the distance to drive down an open road to a destination is shortest, the user can find the next exit with ease.

Further, according to this embodiment, entrances located within a circle with a radius of L1 (km) with the present position at the center are only retrieved when an entrance list is generated. Therefore, unproductive computation and presentation of useless information are eliminated. Also, when an exit list is generated, exits located with a circle with a radius of L2 (km) with the destination at the center are only retrieved. Therefore, unproductive computation and presentation of useless information are also eliminated.

Furthermore, for instance, entrances can be extracted from the following: the entrance at the shortest linear distance from a present position or a search reference position, a predetermined number of entrances counted from this entrance in the up direction, and a predetermined number of entrances counted from this entrance in the down direction. This also results in eliminating unproductive computation and presentation of useless information.

In an entrance list or an exit list, the distances to drive from the present position to entrances or the distances to drive from exits to the destination are indicated in addition to the names of the entrances or exits. Therefore, a user can refer to the distances to drive indicated in the list when selecting an entrance or exit. This is convenient to the user. A distance to drive can be considered to substantially correspond to the driving time therefor.

(Second Embodiment)

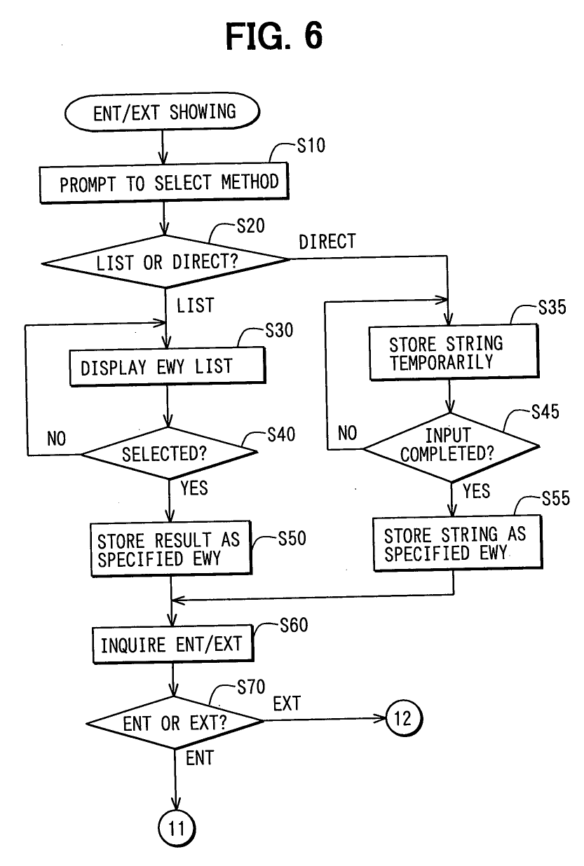

Next, a second embodiment will be described. The constitution of the device in the second embodiment is the same as in the above-mentioned embodiment (first embodiment). In the second embodiment, processing for showing the entrances and exits of an expressway is performed based on a computer program which follows the procedure illustrated in FIG. 6 to FIG. 8. This processing is initiated when the user inputs an actuation signal through the operating switch group 22 or the remote controller 27.

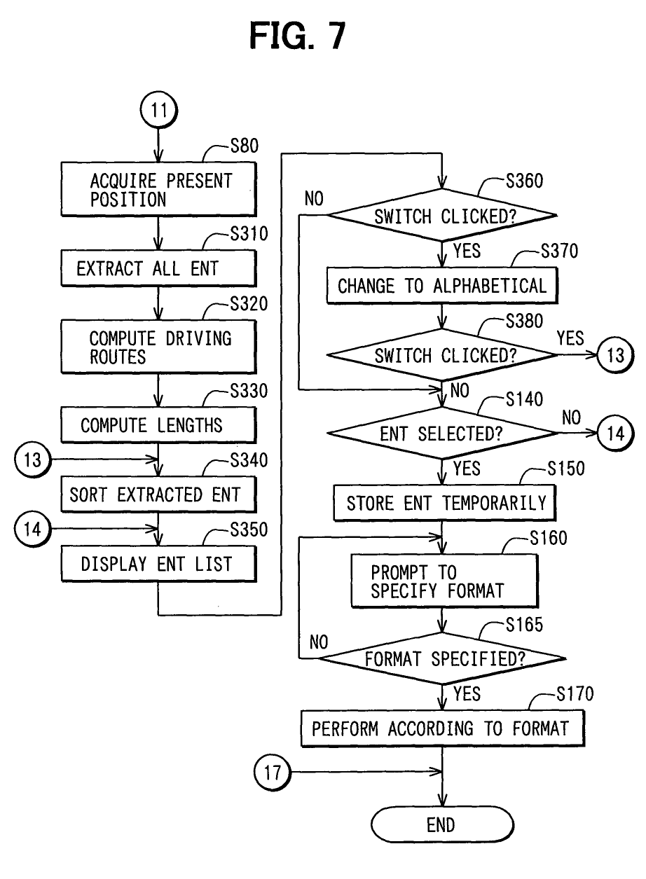

As illustrated in FIG. 6 to FIG. 8, the processing for showing the entrances and exits of an expressway, performed in the second embodiment, is substantially the same as in the first embodiment. Therefore, the same step numbers will be assigned to the same processing steps as in the first embodiment, and the detailed description thereof will be omitted. In the second embodiment, the user operates the operating switch group 22 or the remote controller 27 to determine a specified expressway and select the display of entrances (S10 to S70). When that is detected, the present position is acquired from the position sensor 10, as illustrated in FIG. 7 (S80). Further, all the entrances of the specified expressway are extracted (S310).

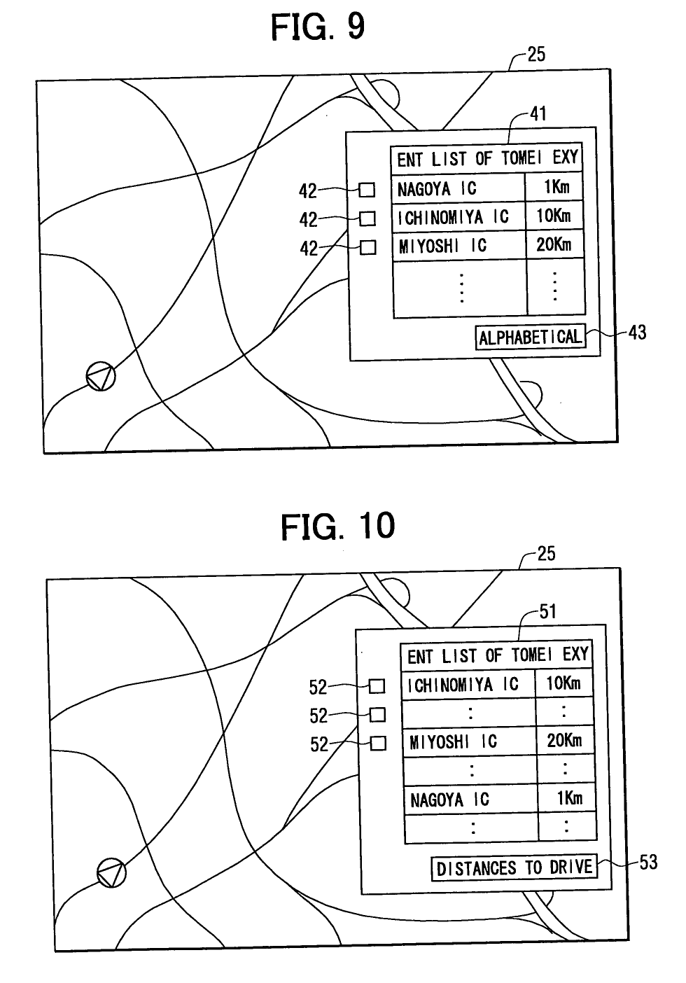

Subsequently, driving routes with the present position acquired at S80 taken as point of departure and all the entrances of the specified expressway extracted at S310 taken as objective points are computed (S320). These driving routes are computed by the same technique as in route computation in ordinary drive routing assistance processing. Information on traffic jams and road construction is also taken into account. Thereafter, the lengths of the individual driving routes (distances to drive) are computed (S330), and the entrances of the specified expressway are sorted in ascending order of the distances to drive (S340). A list based on the result of this sorting is displayed on the display unit 25 (S350). In the list, the entrances of the specified expressway and the distances to drive computed at S330 are listed in pairs in ascending order of the distances to drive. At this time, a changeover switch 43 is displayed, together with the entrance list 41 and the fields 42 for selection, on the display unit 25, as illustrated in FIG. 9. This changeover switch 43 is for changing the sequence of all the entrances of the specified expressway to alphabetical sequence with respect to interchange name.

Thus, the entrance list 41 of the names of interchanges as entrances and the corresponding distances to drive in pairs is displayed in ascending order of the distances to drive. Because of the foregoing, in the second embodiment, it is thereafter determined whether the changeover switch 43 has been clicked (S360). If it is detected that the changeover switch 43 has been clicked (S360: YES), the display is changed to an entrance list of the entrances of the specified expressway in alphabetical sequence (S370). FIG. 10 illustrates an example of the display. An entrance list 51 of the names of the entrances and the distances to drive in alphabetical sequence is in turn displayed on the display unit 25, as illustrated in the figure. This time, a changeover switch 53 is displayed together with the fields 52 for selection. If, with the list in alphabetical sequence on display, it is detected that the changeover switch 53 has been clicked (S380: YES), the operation goes back to S340. Thus, the user can turn the display image back to the entrance list 41 in the sequence of the distances to drive, as illustrated in FIG. 9.

Thereafter, the operation waits until any entrance is selected through the operating switch group 22 or the remote controller 27. Then, the operation further waits until a storing format therefor is specified, and processing is performed according to the specified storing format (S140 to S170).

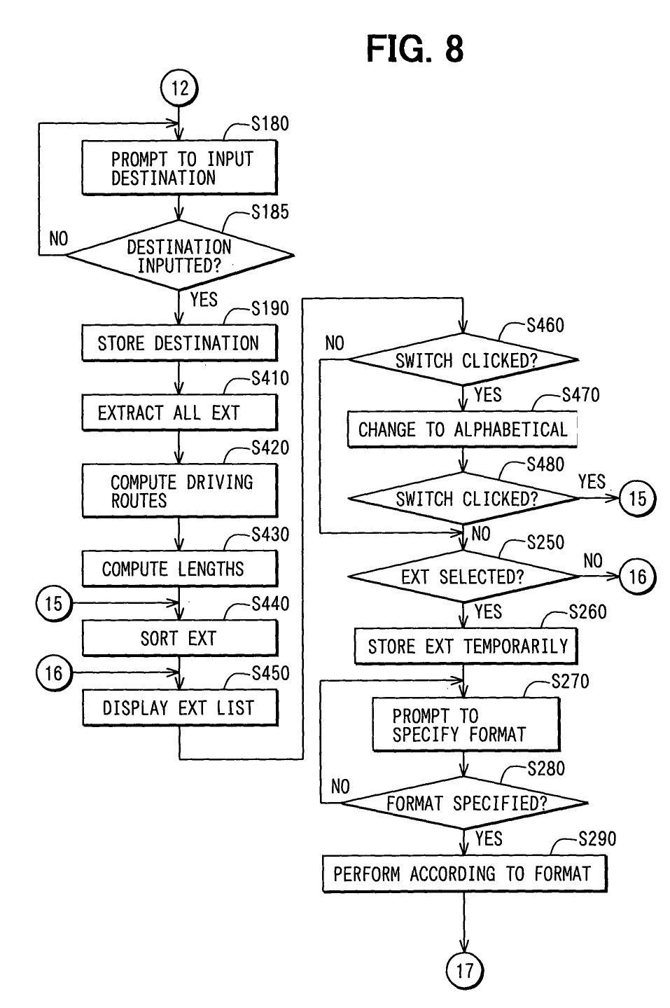

Alternatively, the user may operate the operating switch group 22 or the remote controller 27 to select “exits” (S70: Exits). In this case, a message prompting to input a destination is displayed on the display unit 25, as illustrated in FIG. 8 (S180). When it is detected that a destination has been inputted (S185: YES), the destination is stored (S190), and further, all the exits of the specified expressway are extracted (S410).

Then, driving routes with all the exits extracted at S410 taken as points of departure and the destination stored at S190 taken as objective point are computed by the same technique as in ordinary route computation (S420).

Subsequently, the lengths of the individual driving routes (distances to drive) are computed (S430), and the exits extracted at S410 are sorted in ascending order of the distances to drive (S440). Then, an exit list of the exits in ascending order of the distances to drive, based on the result of this sorting, is displayed on the display unit 25 (S450).

After the completion of the display of the exit list, it is determined whether the changeover switch has been clicked (S460). When it is detected that the changeover switch has been clicked (S460: YES), the display image is changed to an exit list of the exits of the specified expressway in alphabetical sequence (S470). As in the entrance list, when it is detected that the changeover switch has been clicked again (S480: YES), the operation goes back to S440. Thus, the user can turn the display image back to the exit list in the sequence of the distances to drive.

Thereafter, the operation waits until any exit is selected through the operating switch group 22 or the remote controller 27. Then, the operation further waits until a storing format therefor is specified, and processing is performed according to the specified storing format (S250 to S290).

As described above, according to the second embodiment, a user can switch between the entrance list in ascending order of the distances to drive from the present position and the entrance list in alphabetical sequence. Thus, the navigation device can provide a user with more convenient usage depending on the user's experience. For example, if the user is not acquainted with the names of the interchanges of an expressway and desires to find an entrance to the expressway, the user can use the entrance list in ascending order of the distances to drive. If the user is acquainted with the names of the interchanges of an expressway and desires to find an entrance to the expressway, the user can use the entrance list in alphabetical sequence.

Similarly, according to the second embodiment, a user can switch between the exit list in ascending order of the distances to drive to a destination and the exit list in alphabetical sequence. Thus, the navigation device can provide a user with more convenient usage depending on the user's experience. For example, if the user is not acquainted with the names of the interchanges of an expressway and desires to find an exit from the expressway, the user can use the exit list in ascending order of the distances to drive. If the user is acquainted with the names of the interchanges of an expressway and desires to find an exit from the expressway, the user can use the exit list in alphabetical sequence.

Further, according to the second embodiment, all the entrances of a specified expressway are extracted when an entrance list is displayed. Then, the distances to drive to get there from the present position are computed. Thus, an entrance list without omission is generated.

Here, conditions or the like for extracting entrances need not be preset. Further, cases where conditions are not matched with a user's demand and the user cannot select an optimum entrance are prevented from occurring.

Similarly, according to the second embodiment, all the exits of a specified expressway are extracted when an exit list is displayed. Then, the distances to drive from there to a destination are computed. Therefore, complicated conditions setting is obviated, and omission from the presentation of exits is prevented.

(Third Embodiment)

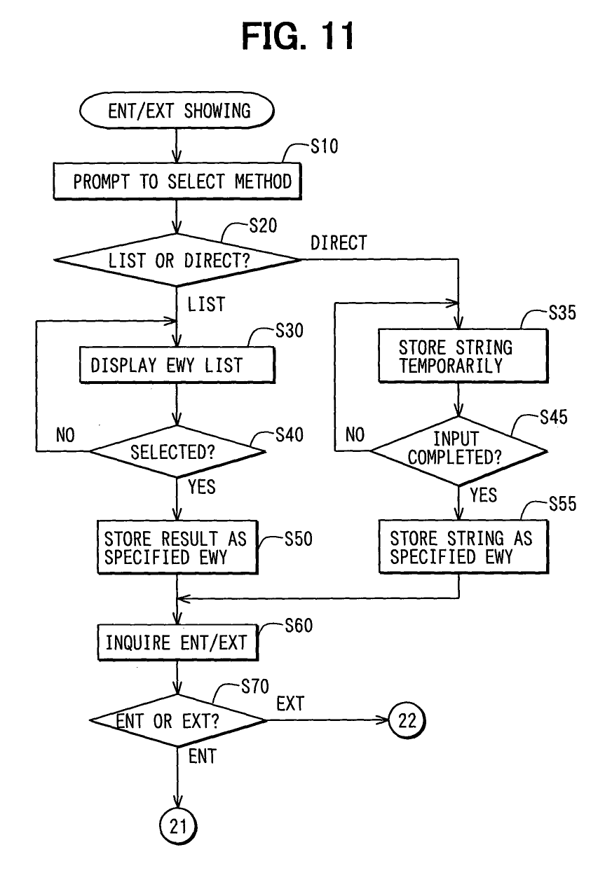

Next, a third embodiment will be described. The constitution of the device in the third embodiment is also the same as in the first embodiment. In the third embodiment, processing for showing the entrances and exits of an expressway is performed based on a computer program which follows the procedure illustrated in FIG. 11 to FIG. 17. This processing is initiated when the user inputs an actuation signal through the operating switch group 22 or the remote controller 27.

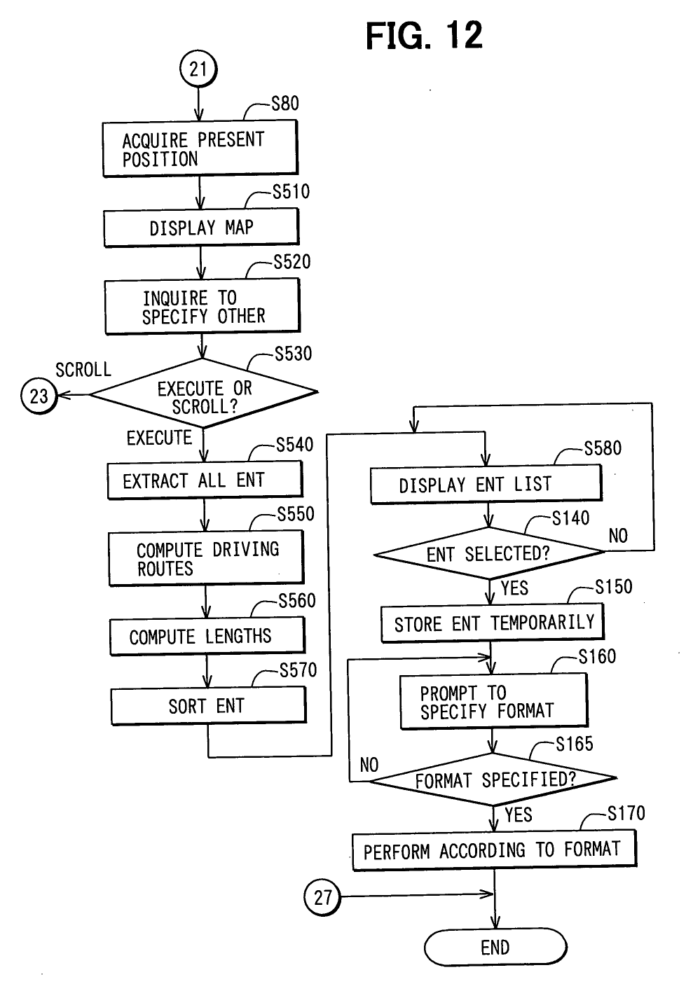

As illustrated in FIG. 11 to FIG. 17, the processing for showing the entrances and exits of an expressway, performed in the third embodiment, is substantially the same as in the first and second embodiments. Therefore, the same step numbers will be assigned to the same processing steps as in the first and second embodiments. The detailed description thereof will be omitted. In the third embodiment, the user operates the operating switch group 22 or the remote controller 27 to determine a specified expressway and select the display of entrances. Thus, the present position is acquired from the position sensor 10, as illustrated in FIG. 11 and FIG. 12 (S10 to S80). Map data corresponding to the present position is read out and displayed on the display unit 25 (S510). At this time, the present position mark is also displayed.

Next, a message is displayed on the display unit 25, inquiring whether to specify any position other than the present position as the search reference position for entrance list display (S520). The user may select “Execute” through the operating switch group 22 or the remote controller 27 (S530: Execute). Then, all the entrances of the specified expressway are immediately extracted as in the second embodiment (S540). Driving routes with the present position, acquired at S80, taken as point of departure and all the entrances of the specified expressway, extracted at S540, taken as objective points are computed (S550). Further, the lengths of the individual driving routes (distances to drive) are computed (S560). Then, the entrances of the specified expressway are sorted in ascending order of the distances to drive to get there (S570). A list based on the result of this sorting is displayed on the display unit 25 (S580). In the list, the entrances of the specified expressway and the distances to drive computed at S110 are listed in pairs in ascending order of the distances to drive. The operation waits until any entrance is selected through the operating switch group 22 or the remote controller 27. Then, the operation further waits until a storing format therefor is specified, and processing is performed according to the specified storing format (S140 to S170).

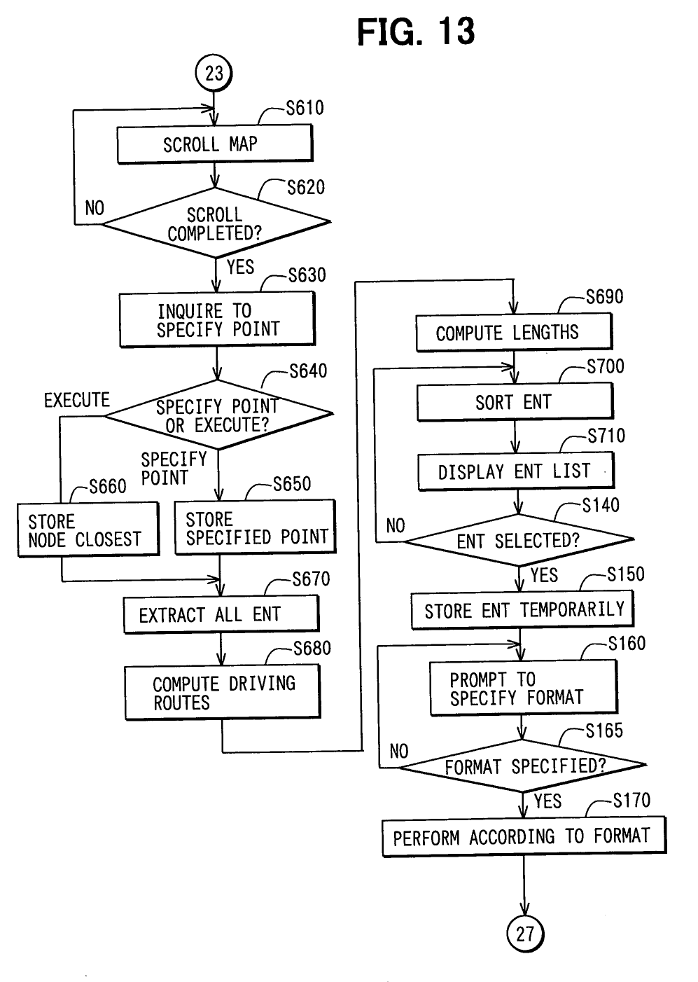

Alternatively, the user may operate the operating switch group 22 or the remote controller 27 to specify a position other than the present position as the search reference position for entrance list display. In this case, when it is detected that the user provides an instruction to scroll the map (S530: Scroll), the map is scrolled according to the instruction to scroll, as illustrated in FIG. 13 (S610). Thereafter, it is determined whether the instruction to scroll has been terminated (S620). As long as it is detected that the instruction to scroll is being inputted (S620: NO), the operation goes back to S610 and scrolling of the map is continued. When it is detected that the instruction to scroll has been terminated (S620: YES), a message is displayed on the display unit 25 (S630). This message is for inquiring whether to specify a point on the presently displayed map as the search reference position.

Here, to determine a search reference position on a map as scrolled, there are various techniques. A position which meets certain conditions in the display screen image may be automatically identified as a search reference position. For example, the center of the map displayed on the display unit 25 is taken as the search reference position, or the corner at the lower left of the displayed map is taken as a search reference position. Or, points which can be identified as a search reference position in the display screen image may be displayed with an appropriate mark. Then, the user can select one from among these points to identify the point as a search reference position.

In this state, the user may operate the operating switch group 22 or the remote controller 27 to specify a point on the map or input “Execute.” If the user specifies a point on the map (S640: Specify point), the position coordinates of the specified point are stored in the RAM as the search reference position (S650). Alternatively, if it is detected that the user has inputted “Execute” (S640: Execute), the node closest to the center of the presently displayed map is stored in the RAM as the search reference position (S660).

When the search reference position is thus determined, all the entrances of the specified expressway are extracted (S670). Driving routes with the search reference position, stored in the RAM at S650 or S660, taken as point of departure and all the entrances of the specified expressway, extracted at S670, taken as objective points are computed (S680). Further, the lengths of the individual driving routes (distances to drive) are computed (S690). The entrances extracted at S670 are sorted in ascending order of the distances to drive to get there (S700). Then, based on the result of this sorting, an entrance list of the entrances and the distances to drive in pairs is displayed on the display unit 25 (S710). The subsequent processing steps are the same as in cases where an entrance list is generated based on the present position of the vehicle concerned and displayed (S140 to S170).

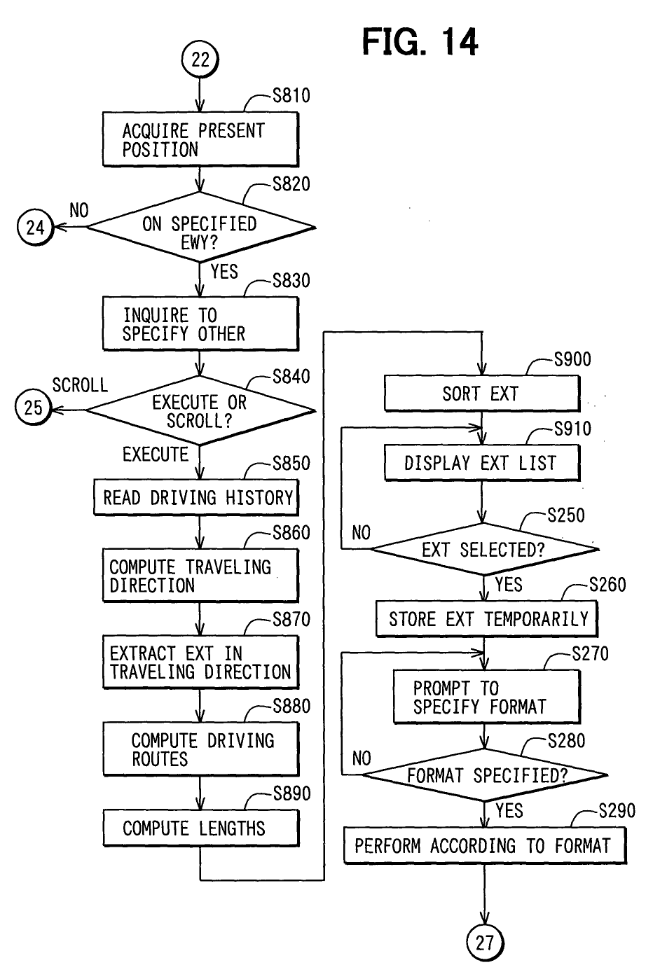

Alternatively, the user may operate the operating switch group 22 or the remote controller 27 to select “Exits” (S70: Exits). In this case, the present position of the vehicle is acquired from the position sensor 10, as illustrated in FIG. 14 (S810). Then, it is determined whether the present position is on the specified expressway (S820). If the present position is determined to be on the specified expressway (S820: YES), a message is displayed on the display unit 25 (S830). The message is for inquiring whether the present position is used as the search reference position for exit list display.

The user may operate the operating switch group 22 or the remote controller 27 to input “Execute.” When that is detected (S840: Execute), the history of change in the present position (driving history) is read out of the external memory 24 (S850). The third embodiment is so constituted that change in the present position is stored as a driving history in the external memory 24. After the driving history is read out, a traveling direction is computed from the driving history (S860). Then, all the exits of the specified expressway, located in the traveling direction relative to the present position, are extracted (S870). Subsequently, driving routes with the present position taken as point of departure and the exits extracted at S870 taken as destinations are computed (S880). This computation is carried out by the same technique as in route computation in ordinary drive routing assistance processing.

Then, the lengths of the individual driving routes (distances to drive) are computed (S890), and the exits extracted at S870 are sorted in ascending order of the distances to drive (S900). Based on the result of this sorting, an exit list in ascending order of the distances to drive is displayed on the display unit 25 (S910). Thereafter, the operation waits until any exit is selected through the operating switch group 22 or the remote controller 27. After an exit is selected, the operation further waits until a storing format therefor is specified, and processing is performed according to the specified storing format (S250 to S290).

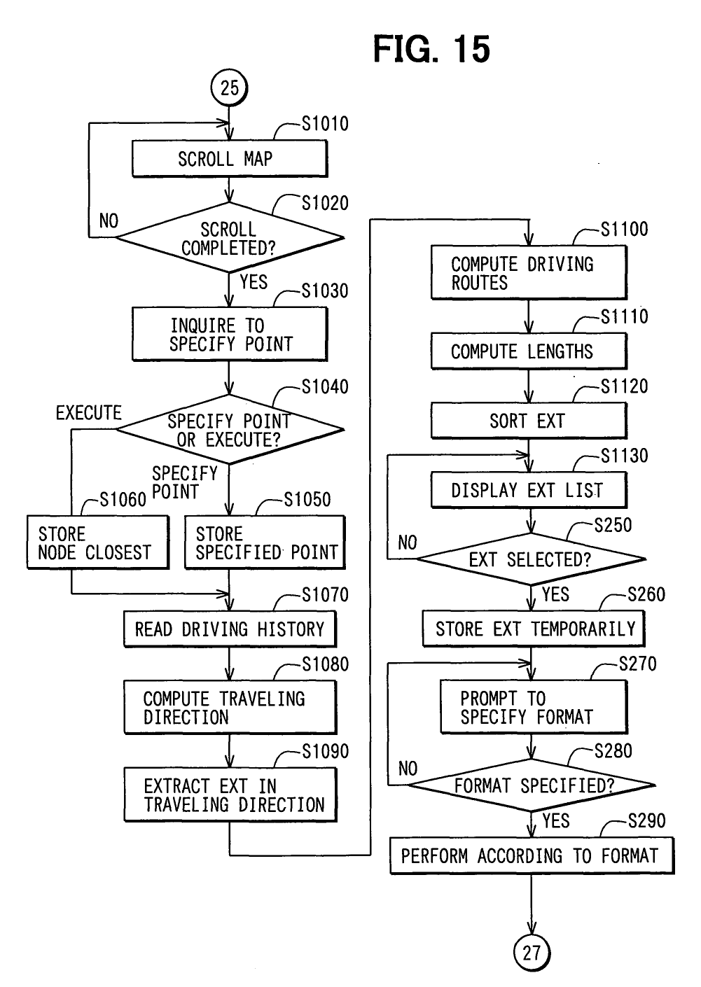

When the present position is on the specified expressway (S820: YES), the user may specify a position other than the present position as the search reference position for exit list display. To do this, the user operates the operating switch group 22 or the remote controller 27 to provide an instruction to scroll a map (S840: Scroll). In this case, the map is scrolled according to the instruction to scroll, as illustrated in FIG. 15 (S1010). Thereafter, it is determined whether the instruction to scroll has been terminated (S1020). As long as it is detected that the instruction to scroll is being inputted (S1020: NO), the operation goes back to S1010 and scrolling of the map is continued. When it is detected that the instruction to scroll has been terminated (S1020: YES), a message is displayed on the display unit 25 (S1030). This message is for inquiring whether to specify a point on the presently displayed map as the search reference position.

The user may operate the operating switch group 22 or the remote controller 27 to specify a point on the map or input “Execute.” If the user specifies a point, for example, a service area, on the map (S1040: Specify point), the position coordinates of the specified point are stored in the RAM as the search reference position (S1050). Alternatively, if the user inputs “Execute” (S1040: Execute), the node closest to the center of the presently displayed-map is stored in the RAM as the search reference position (S1060).

When the search reference position is thus determined, the driving history is read out of the external memory 24 (S1070). Based on the driving history read out at S1070, the traveling direction is computed (S1080). Then, all the exits of the specified expressway, located in the traveling direction relative to the search reference position determined at S1050 or S1060, are extracted (S1090). Subsequently, driving routes with the search reference position, determined at S1050 or S1060, taken as point of departure and the exits, extracted at S1090, taken as destinations are computed (S1100). This computation is carried out by the same technique as in route computation in ordinary drive routing assistance processing.

Then, the lengths of the individual driving routes (distances to drive) are computed (S1110), and the exits extracted at S1090 are sorted in ascending order of the distances to drive (S1120). Based on the result of this sorting, an exit list in ascending order of the distances to drive is displayed on the display unit 25 (S1130). Thereafter, the operation waits until any exit is selected through the operating switch group 22 or the remote controller 27. After an exit is selected, the operation further waits until a storing format therefor is specified, and processing is performed according to the specified storing format (S250 to S290).

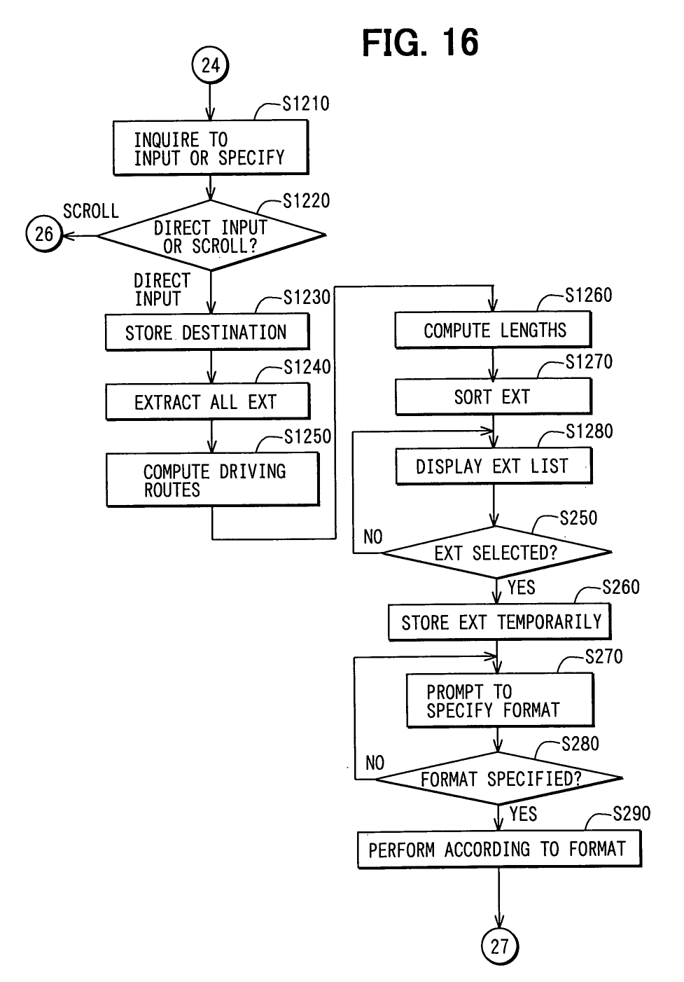

Alternatively, when the present position is not on the specified expressway (S820: NO), a message is displayed on the display unit 25 (S1210). This message is for inquiring whether to directly input a destination or specify it on a map, as illustrated in FIG. 16. If the user directly inputs a destination by facility name, facility phone number, municipality name, unique location code, or the like (S1220: Direct input), the destination is stored in the RAM (S1230). Further, all the exits of the specified expressway are extracted (S1240).

Subsequently, driving routes with the exits, extracted at S1240, taken as points of departure and the destination, stored at S1230, taken as objective point are computed (S1250). This driving route computation is also the same as in ordinary route computation. Then, the lengths of the individual driving routes (distances to drive) are computed (S1260), and the exits extracted at S1240 are sorted in ascending order of the distances to drive (S1270). An exit list based on the result of this sorting is displayed on the display unit 25 (S1280). In the exit list, the exits extracted at S1240 and the distances to drive computed at S1260 are listed in pairs in ascending order of the distances to drive. Thereafter, the operation waits until any exit is selected through the operating switch group 22 or the remote controller 27. After an exit is selected, the operation further waits until a storing format therefor is specified, and processing is performed according to the specified storing format (S250 to S290).

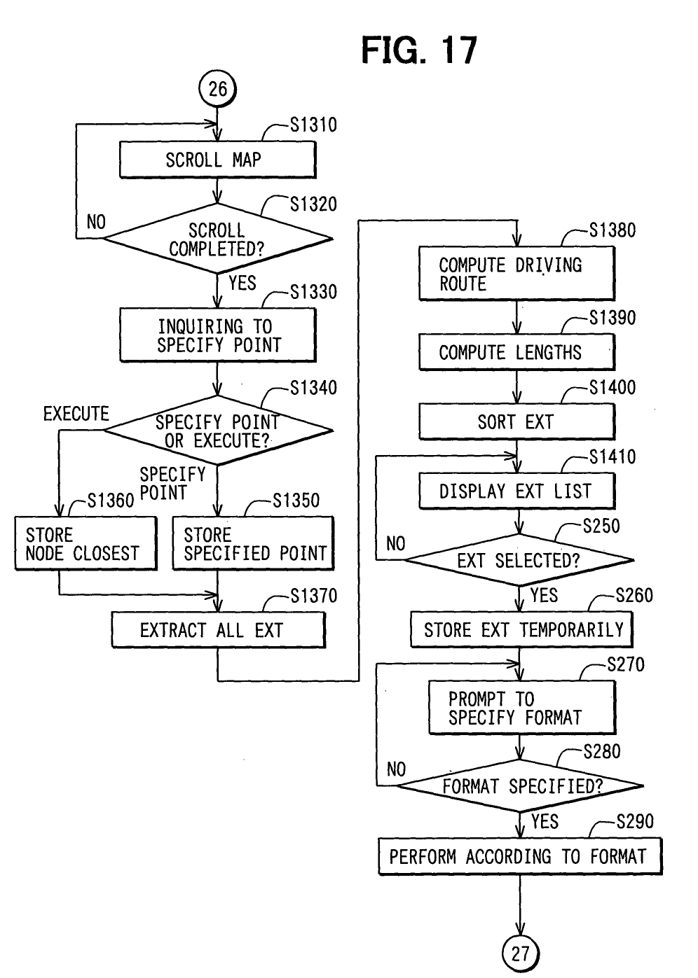

Alternatively, the user may desire to scroll the map to specify a destination on the map. When it is detected that the user has provided an instruction to scroll the map (S1220: Scroll), the map is scrolled according to the instruction to scroll, as illustrated in FIG. 17 (S1310). Thereafter, it is determined whether the instruction to scroll has been terminated (S1320). As long as it is detected that the instruction to scroll is being inputted (S1320: NO), the operation goes back to S1310 and scrolling of the map is continued. When it is detected that the instruction to scroll has been terminated (S1320: YES), a message is displayed on the display unit 25 (S1330). This message is for inquiring whether to specify a point on the presently displayed map as the search reference position.

In this state, the user may operate the operating switch group 22 or the remote controller 27 to specify a point on the map or input “Execute.” If it is detected that the user has specified a point on the map (S1340: Specify point), the position coordinates of the specified point are stored in the RAM as the search reference position (S1350). Alternatively, if it is detected that the user has inputted “Execute” (S1340: Execute), the node closest to the center of the presently displayed map is stored in the RAM as the search reference position (S1360).

When the search reference position is thus determined, all the exits of the specified expressway are extracted (S1370). Driving routes with the exits of the specified expressway, extracted at S1370, taken as points of departure and the search reference position, stored in the RAM at S1350 or S1360, taken as objective point are computed (S1380). Further, the lengths of the individual driving routes (distances to drive) are computed (S1390). Then, exits extracted at S1370 are sorted in ascending order of the distances to drive (S1400). Then, based on the result of this sorting, an exit list of the exits and the distances to drive in pairs is displayed on the display unit 25 (S1410). Thereafter, the operation waits until any exit is elected through the operating switch group 22 or the remote controller 27. After an exit is selected, the operation further waits until a storing format therefor is specified, and processing is performed according to the specified storing format (S250 to S290).

According to the third embodiment, the user can specify a search reference position other than the present position when an entrance list is presented. This function is convenient to a user who is going to stop over at a restaurant or a souvenir store before getting on an expressway. The function meets the user's desire to find an entrance at the shortest distance from the stopover.

Further, according to the third embodiment, when an entrance list is generated to carry out the above-mentioned function, a search reference position therefor can be easily specified by the scrolling function. Further, when a search reference position is specified on a map as scrolled, the user has a choice between two methods: directly specifying a point and specifying it based on the conditions provided in advance in the software.

Further, according to the third embodiment, the user can specify a search reference position other than the present position when an exit list is presented. This function is convenient to a user driving down an expressway who is going to stop over at some service area before getting off the expressway. The function can extract exits in the traveling direction relative to the stopover and present an exit list in ascending order of the distances to drive from the stopover to get there. Therefore, the function can meet a user's desire when the user is not going to immediately get off an expressway but wants to check exits to which driving routes lead from a stopover on the expressway.

Further, according to the third embodiment, when an exit list is generated to carry out the above-mentioned function, a search reference position therefor can be easily specified by the scrolling function. Further, when a search reference position is specified on a map as scrolled, the user has a choice between two methods: directly specifying a point and specifying it based on the conditions provided in advance in the software.

(Fourth Embodiment)

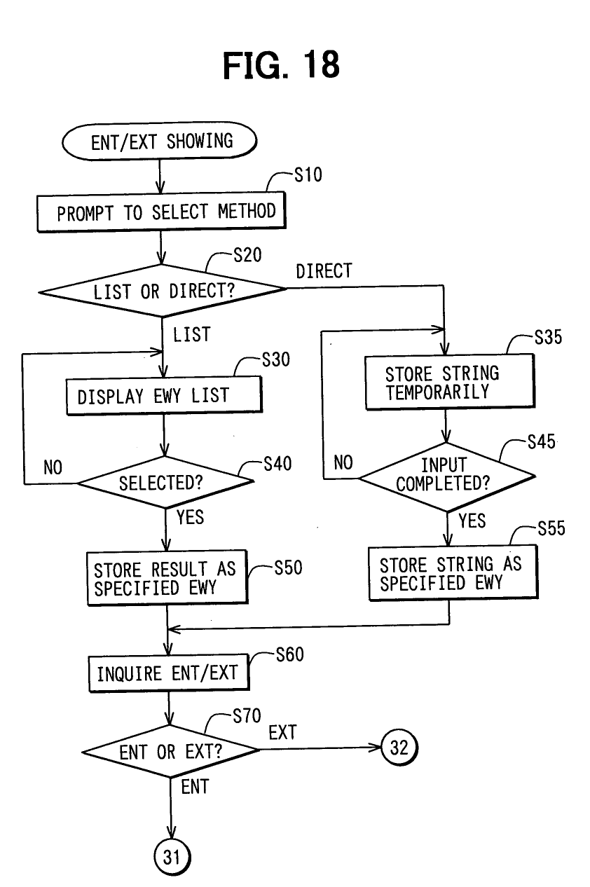

Next, a fourth embodiment will be described. The constitution of the device in the fourth embodiment is also the same as in the first embodiment. In the fourth embodiment, processing for showing the entrances and exits of an expressway is performed based on a computer program which follows the procedure illustrated in FIG. 18 to FIG. 20. This processing is initiated when the user inputs an actuation signal through the operating switch group 22 or the remote controller 27.

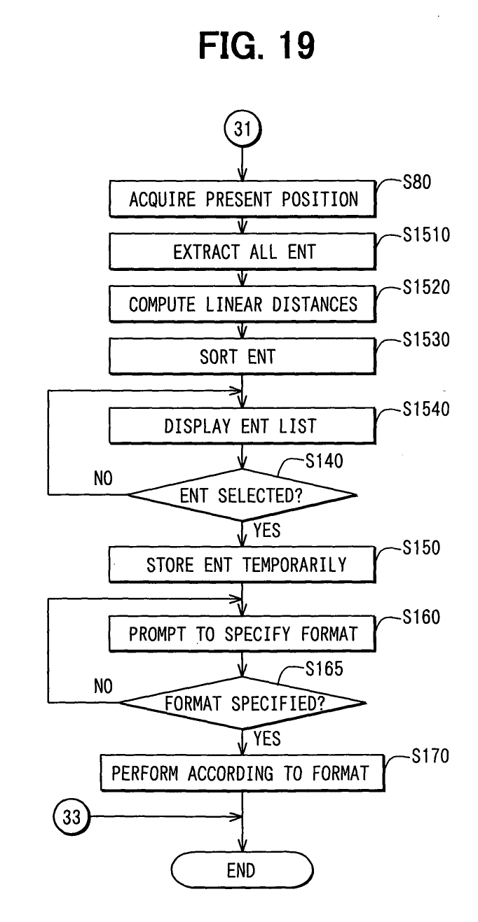

As illustrated in FIG. 18 to FIG. 20, the processing for showing the entrances and exits of an expressway, performed in the third embodiment, is substantially the same as in the first embodiment. Therefore, the same step numbers will be assigned to the same processing steps as in the first embodiment. The detailed description thereof will be omitted. In the fourth embodiment, the user operates the operating switch group 22 or the remote controller 27 to determine a specified expressway and select the display of entrances (S10 to S70). Thus, the present position is acquired from the position sensor 10, as illustrated in FIG. 19 (S80). Further, all the entrances of the specified expressway are extracted (S1510).

Subsequently, the linear distances between the present position acquired at S80 and all the entrances of the specified expressway extracted at S1510 are computed (S1520). Then, the entrances of the specified expressway are sorted in ascending order of the linear distances from the present position (S1530). A list based on the result of this sorting is displayed on the display unit 25 (S1540). In the list, the entrances of the specified expressway and the linear distances computed at S1520 are listed in pairs in ascending order of the linear distances.

Thereafter, the operation waits until any entrance is selected through the operating switch group 22 or the remote controller 27. When an entrance is selected, the operation further waits until a storing format therefor is specified, and processing is performed according to the specified storing format (S140 to S170).

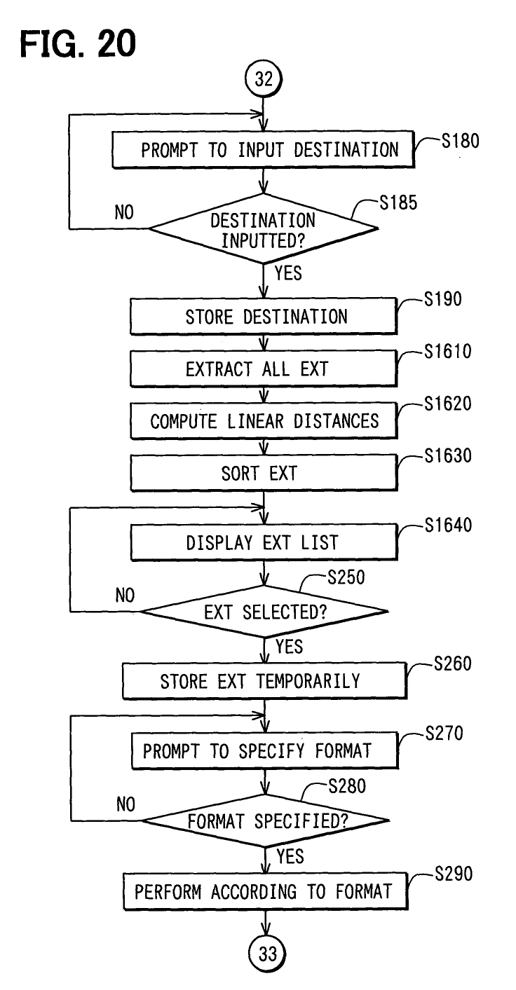

Alternatively, the user may operate the operating switch group 22 or the remote controller 27 to select exits. When that is detected (S70: Exits), a message prompting to input a destination is displayed on the display unit 25, as illustrated in FIG. 20 (S180). When it is detected that a destination has been inputted (S185: YES), the destination is stored (S190), and further, all the exits of the specified expressway are extracted (S1610). Then, the linear distances between all the exits extracted at S1610 and the destination stored at S190 are computed (S1620).

Subsequently, the exits extracted at S1610 are sorted in ascending order of the linear distances (S1630). Then, an exit list of the exits sorted in ascending order of the linear distances is displayed on the display unit 25 based on the result of this sorting (S1640).

After the display of the exit list is thus completed, the operation waits until any exit is selected through the operating switch group 22 or the remote controller 27. When an exit is selected, the operation further waits until a storing format therefor is specified, and processing is performed according to the specified storing format (S250 to S290).

Here, the linear distance between two points and the driving time therefor correspond to each other to some degree. In general, the longer the linear distance is, the longer the driving time therefor is, and the shorter the linear distance is, the shorter the driving time therefor is.

As described above, according to the fourth embodiment, an entrance list of the entrances of an expressway in ascending order of the linear distances from the present position can be presented to the user. At this time, the linear distances are listed together with the names of the entrances in the entrance list.

Further, according to the fourth embodiment, an exit list of the exits of an expressway in ascending order of the linear distances to the destination can be presented to the user. At this time, the linear distances are listed together with the names of the exits in the exit list.

(Fifth Embodiment)

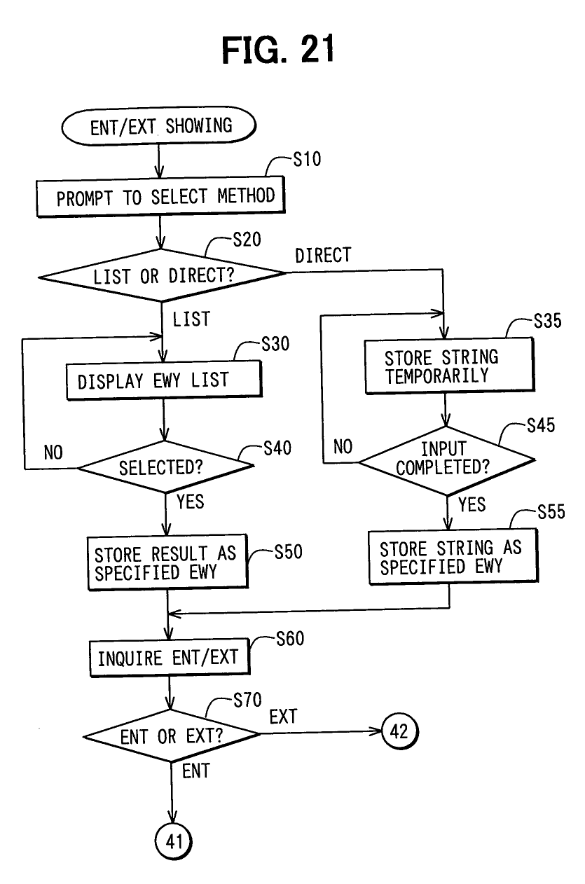

Next, a fifth embodiment will be described. The constitution of the device in the fifth embodiment is also the same as in the first embodiment. In the fifth embodiment, processing for showing the entrances and exits of an expressway is performed based on a computer program which follows the procedure illustrated in FIG. 21 to FIG. 30. This processing is initiated when the user inputs an actuation signal through the operating switch group 22 or the remote controller 27.

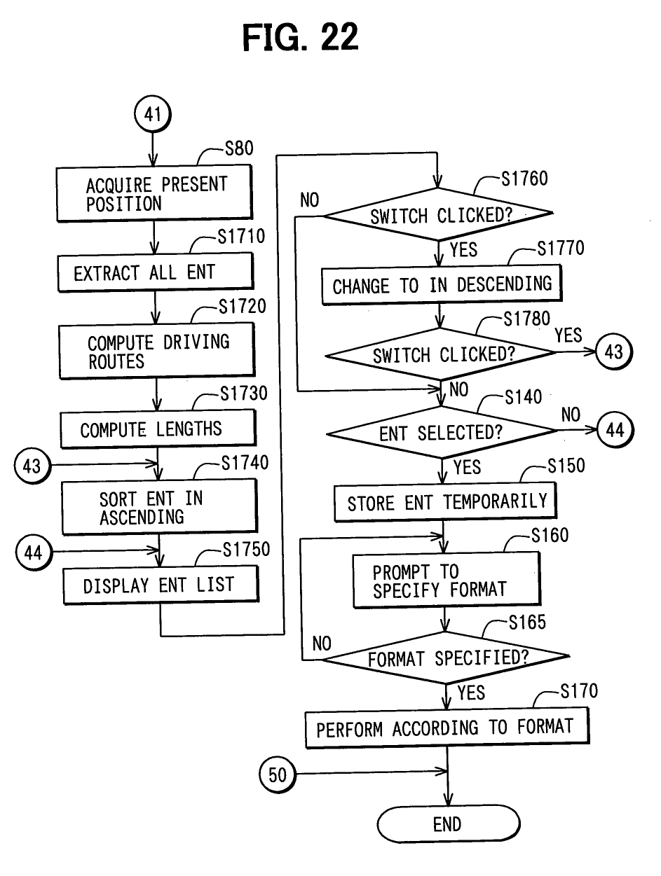

As illustrated in FIG. 21 to FIG. 30, the processing for showing the entrances and exits of an expressway, performed in the fifth embodiment, is substantially the same as in the first embodiment. Therefore, the same step numbers will be assigned to the same processing steps as in the first embodiment. The detailed description thereof will be omitted. In the fifth embodiment, the user operates the operating switch group 22 or the remote controller 27 to determine a specified expressway and select the display of entrances (S10 to S70). When that is detected, the present position is acquired from the position sensor 10, as illustrated in FIG. 22 (S80). Further, all the entrances of the specified expressway are extracted (S1710).

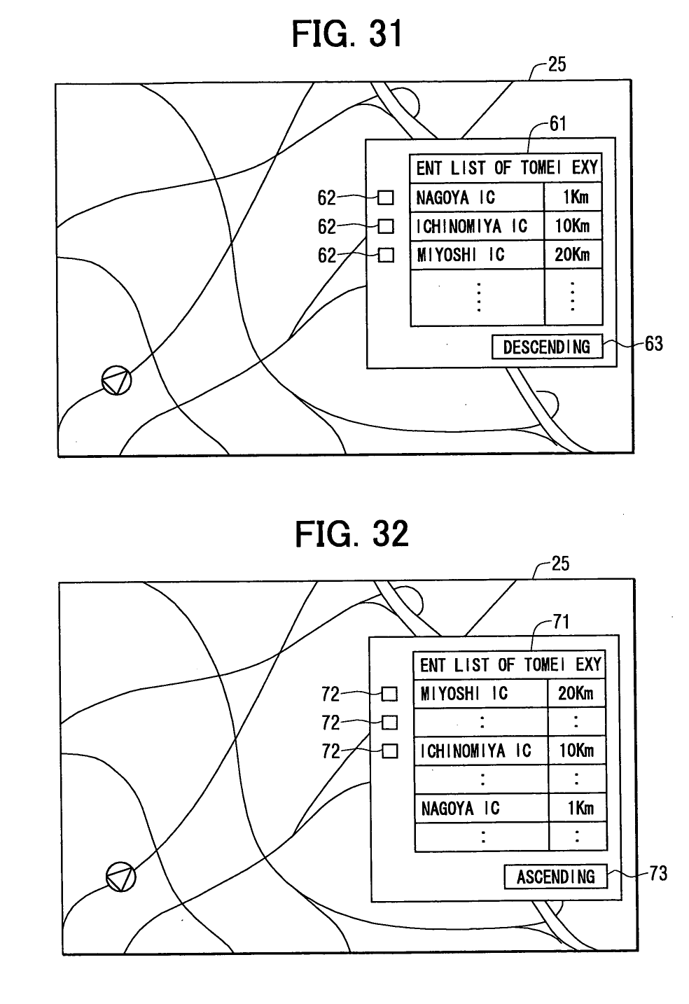

Subsequently, driving routes with the present position acquired at S80 taken as point of departure and all the entrances of the specified expressway extracted at S1710 taken as objective points are computed (S1720). Then, the lengths of the individual driving routes (distances to drive) are computed (S1730). The entrances of the specified expressway are sorted in ascending order of the distances to drive (S1740). A list based on the result of this sorting is displayed on the display unit 25 (S1750). In the list, the entrances of the specified expressway and the distances to drive computed at S1730 are listed in pairs in ascending order of the distances to drive. At this time, a changeover switch 63 is displayed, together with the entrance list 61 and the fields 62 for selection, on the display unit 25, as illustrated in FIG. 31. This changeover switch 63 is for sorting and displaying all the entrances of a specified expressway in descending order of the distances to drive.

Thus, the entrance list 61 of the entrances is displayed in ascending order of the distances to drive. Because of the foregoing, in the fifth embodiment, it is thereafter determined whether the changeover switch 63 has been clicked (S1760). If it is detected that the changeover switch 63 has been clicked (S1760: YES), the display image is changed to an entrance list of the entrances of the specified expressway in descending order of the distances to drive (S1770). FIG. 32 illustrates an example of the display. An entrance list 71 of the names of the entrances and the distances to drive in descending order of the distances to drive is in turn displayed on the display unit 25, as illustrated in the figure. This time, a changeover switch 73 is displayed together with the fields 72 for selection. If, with the list 71 on display, it is detected that the changeover switch 73 has been clicked (S1780: YES), the operation goes back to S1740. Thus, the user can turn the display image back to the entrance list 61 in ascending order of the distances to drive, as illustrated in FIG. 31.

Thereafter, the operation waits until any entrance is selected through the operating switch group 22 or the remote controller 27. Then, the operation further waits until a storing format therefor is specified, and processing is performed according to the specified storing format (S140 to S170).

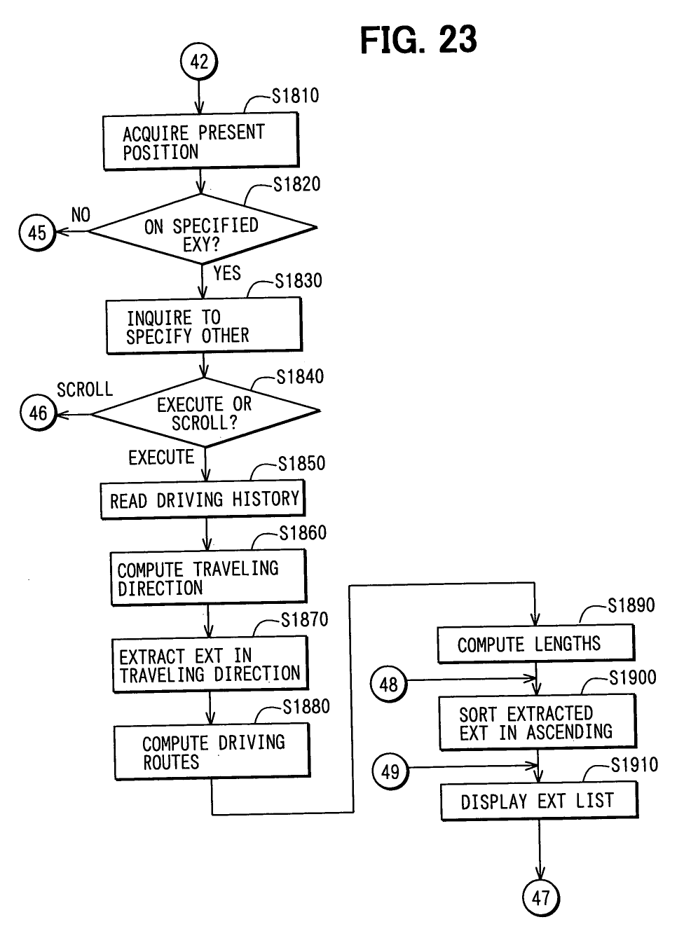

Alternatively, the user may operate the operating switch group 22 or the remote controller 27 to select exits. When that is detected (S70: Exits), the present position of the vehicle is acquired from the position sensor 10, as illustrated in FIG. 23 (S1810). Then, it is determined whether the present position is on the specified expressway (S1820). If the present position is determined to be on the specified expressway (S1820: YES), a message is displayed on the display unit 25 (S1830). The message is for inquiring whether the present position is used as the search reference position for exit list display.

The user may operate the operating switch group 22 or the remote controller 27 to input “Execute.” When that is detected (S1840: Execute), the driving history is read out of the external memory 24 (S1850). After the driving history is thus read out, the traveling direction is computed from the driving history (S1860). Then, all the exits of the specified expressway, located in the traveling direction relative to the present position, are extracted (S1870). Subsequently, driving routes with the present position taken as point of departure and the exits extracted at S1870 taken as destinations are computed (S1880). This computation is carried out by the same technique as in route computation in ordinary drive routing assistance processing.

Then, the lengths of the individual driving routes (distances to drive) are computed (S1890), and the exits extracted at S1870 are sorted in ascending order of the distances to drive (S1900). Based on the result of this sorting, an exit list in ascending order of the distances to drive is displayed on the display unit 25 (S1910).

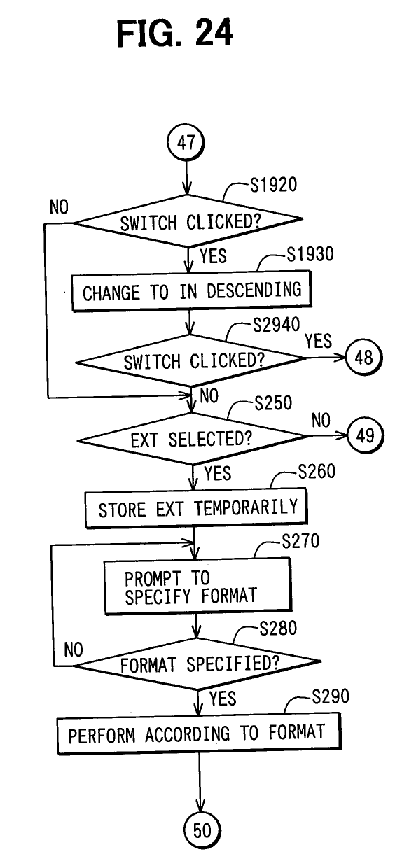

After the display of the exit list is thus completed, it is determined whether the changeover switch has been clicked, as illustrated in FIG. 24 (S1920). When it is detected that the changeover switch has been clicked (S1920: YES), the display image is changed to an exit list of the exits of the specified expressway in descending order of the distances to drive (S1930). As in the entrance list, when it is detected that the changeover switch has been clicked again (S1940: YES), the operation goes bock to S1900. Thus, the user can turn the display image back to the exit list in ascending order of the distances to drive.

Thereafter, the operation waits until any exit is selected through the operating switch group 22 or the remote controller 27. Then, the operation further waits until a storing format therefor is specified, and processing is performed according to the specified storing format (S250 to S290).

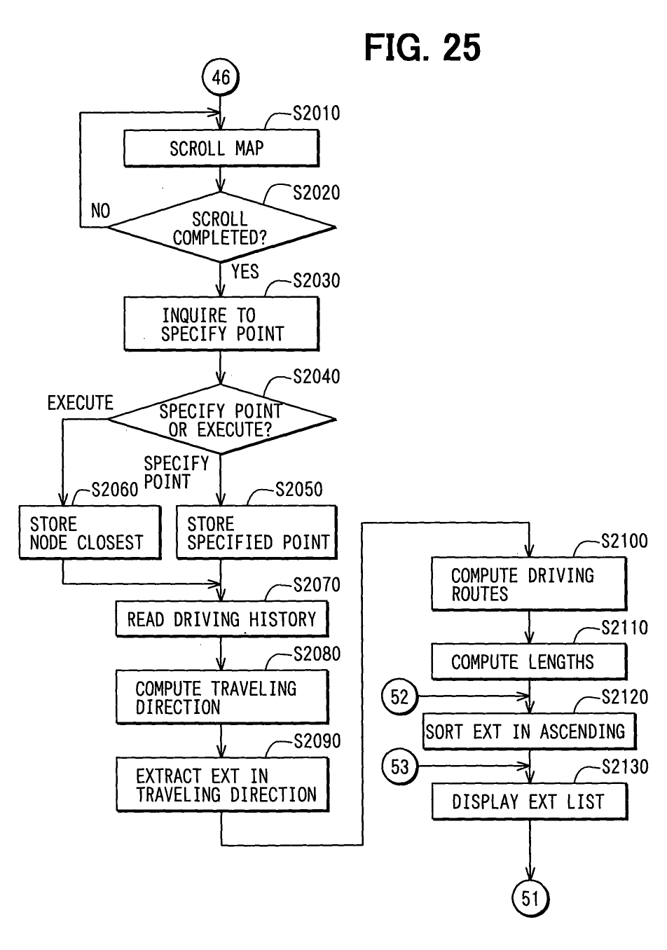

When the present position is on the specified expressway (S1820: YES), the user may specify a position other than the present position as the search reference position for exit list display. To do this, the user operates the operating switch group 22 or the remote controller 27 to provide an instruction to scroll a map (S1840: Scroll). In this case, the map is scrolled according to the instruction to scroll, as illustrated in FIG. 25 (S2010). Thereafter, it is determined whether the instruction to scroll has been terminated (S2020). As long as it is detected that the instruction to scroll is being inputted (S2020: NO), the operation goes back to S2010 and scrolling of the map is continued. When the instruction to scroll is terminated (S2020: YES), a message is displayed on the display unit 25 (S2030). The message is for inquiring whether to specify a point on the presently displayed map as the search reference position.

The user may operate the operating switch group 22 or the remote controller 27 to specify a point on the map or input “Execute.” If the user specifies a point, for example, a service area, on the map (S2040: Specify point), the position coordinates of the specified point are stored in the RAM as the search reference position (S2050). Alternatively, if the user inputs “Execute” (S2040: Execute), the node closest to the center of the presently displayed map is stored in the RAM as the search reference position (S2060).

When the search reference position is thus determined, the driving history is read out of the external memory 24 (S2070). Based on the driving history read out at S2070, the traveling direction is computed (S2080). Then, all the exits of the specified expressway, located in the traveling direction relative to the search reference position, determined at S2050 or S2060 are extracted (S2090). Subsequently, driving routes with the search reference position, determined at S2050 or S2060, taken as point of departure and the exits, extracted at S2090, taken as destinations are computed (S2100). This computation is carried out by the same technique as in ordinary route computation.

Then, the lengths of the individual driving routes (distances to drive) are computed (S2110), and the exits extracted at S2080 are sorted in ascending order of the distances to drive (S2120). Based on the result of this sorting, an exit list in ascending order of the distances to drive is displayed on the display unit 25 (S2130).

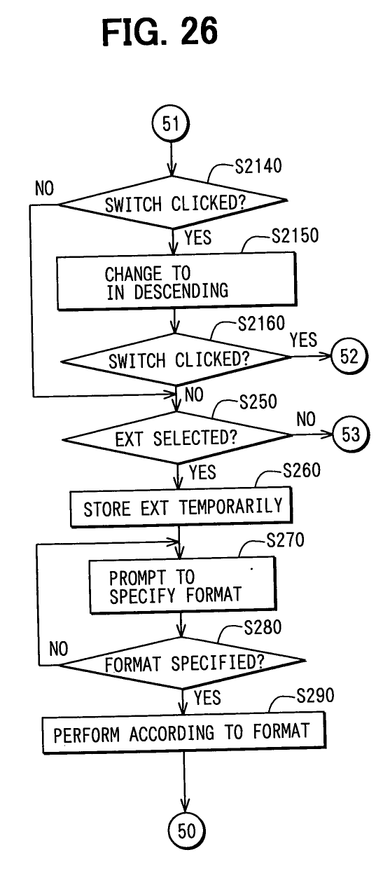

After the display of the exit list is thus completed, it is determined whether the changeover switch has been clicked, as illustrated in FIG. 26 (S2140). When it is detected that the changeover switch has been clicked (S2140: YES), the display image is changed to an exit list of the exits of the specified expressway in descending order of the distances to drive (S2150). As in the entrance list, when it is detected that the changeover switch has been clicked again (S2160: YES), the operation goes back to S2120. Thus, the user can turn the display image back to the exit list in ascending order of the distances to drive.

Thereafter, the operation waits until any exit is selected through the operating switch group 22 or the remote controller 27. Then, the operation further waits until a storing format therefor is specified, and processing is performed according to the specified storing format (S250 to S290).

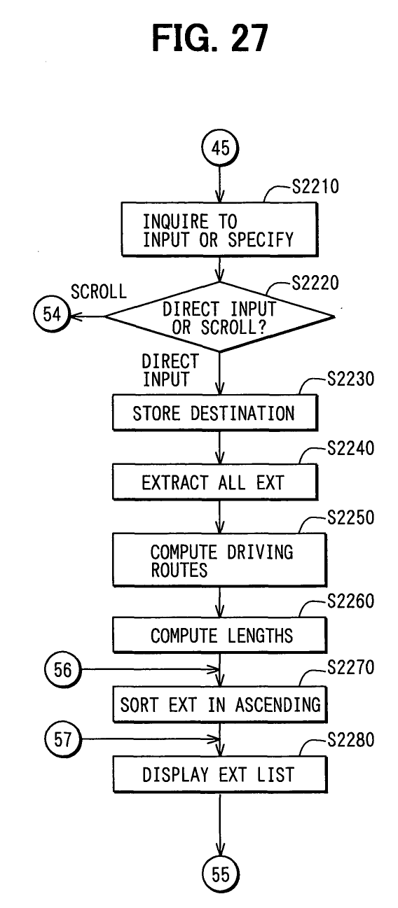

Alternatively, when the present position is not on the specified expressway (S1820: NO), a message is displayed on the display unit 25 (S2210). This message is for inquiring whether to directly input a destination or specify it on a map, as illustrated in FIG. 27. If the user directly inputs a destination by facility name, facility phone number, municipality name, unique location code, or the like (S2220: Direct input), the destination is stored in the RAM (S2230). Further, all the exits of the specified expressway are extracted (S2240).

Subsequently, driving routes with the exits, extracted at S2240, taken as points of departure and the destination, stored at S2230, taken as objective point are computed (S2250). This driving route computation is also the same as in ordinary route computation. Then, the lengths of the individual driving routes (distances to drive) are computed (S2260), and the exits extracted at S2240 are sorted in ascending order of the distances to drive (S2270). An exit list based on the result of this sorting is displayed on the display unit 25 (S2280). In the exit list, the exits extracted at S2240 and the distances to drive computed at S2260 are listed in pairs in ascending order of the distances to drive.

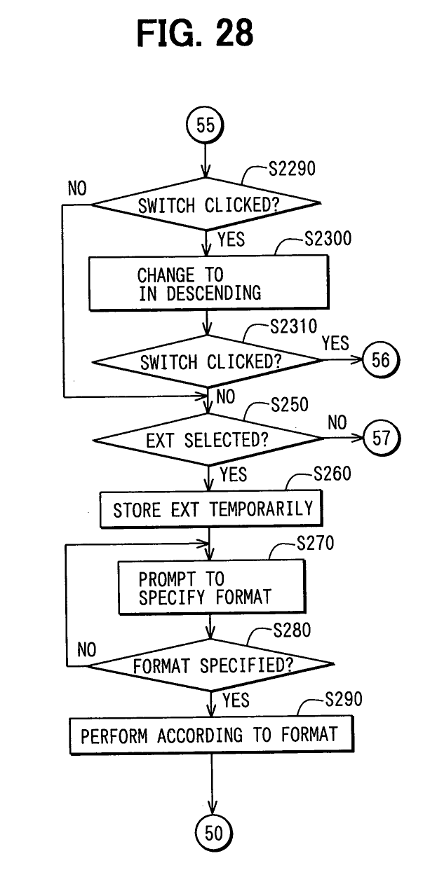

After the display of the exit list is thus completed, it is determined whether the changeover switch has been clicked, as illustrated in FIG. 28 (S2290). When it is detected that the changeover switch has been clicked (S2290: YES), the display image is changed to an exit list of the exits of the specified expressway in descending order of the distances to drive (S2300). As in the entrance list, when it is detected that the changeover switch has been clicked again (S2310: YES), the operation goes back to S2270. Thus, the user can turn the display image back to the exit list in ascending order of the distances to drive.

Thereafter, the operation waits until any exit is selected through the operating switch group 22 or the remote controller 27. Then, the operation further waits until a storing format therefor is specified, and processing is performed according to the specified storing format (S250 to S290).

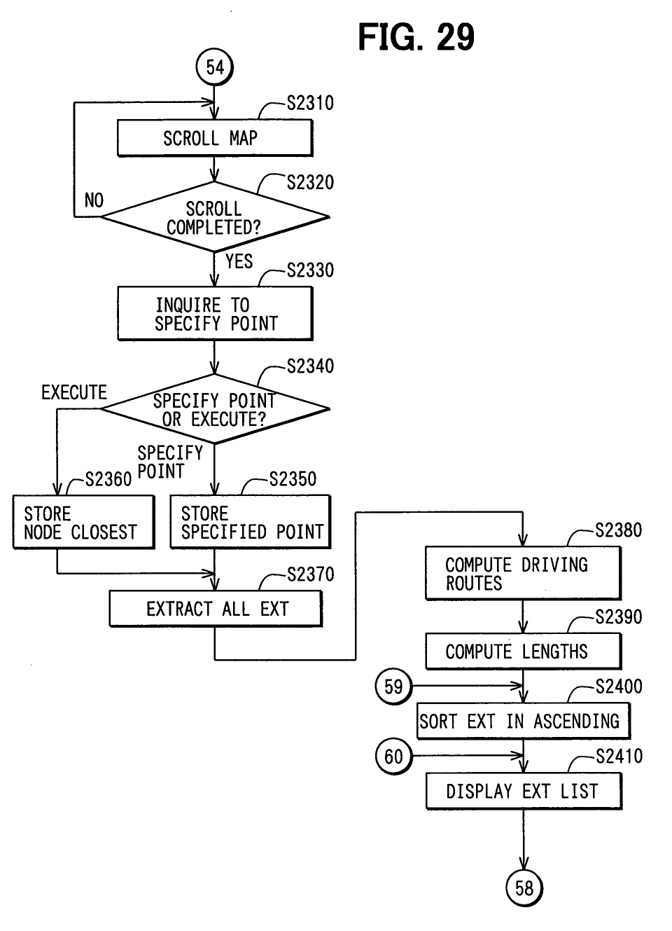

Alternatively, the user may desire to scroll the map to specify a destination on the map. When it is detected that the user has provided an instruction to scroll the map (S2220: Scroll), the map is scrolled according to the instruction to scroll, as illustrated in FIG. 29 (S2310). Thereafter, it is determined whether the instruction to scroll has been terminated (S2320). As long as it is detected that the instruction to scroll is being inputted (S2320: NO), the operation goes back to S2310 and scrolling of the map is continued. When it is detected that the instruction to scroll has been terminated (S2320: YES), a message is displayed on the display unit 25 (S2330). This message is for inquiring whether to specify a point on the presently displayed map as the search reference position.

In this state, the user may operate the operating switch group 22 or the remote controller 27 to specify a point on the map or input “Execute.” If it is detected that the user has specified a point on the map (S2340: Specify point), the position coordinates of the specified point are stored in the RAM as the search reference position (S2350). Alternatively, if it is detected that the user has inputted “Execute” (S2340: Execute), the node closest to the center of the presently displayed map is stored in the RAM as the search reference position (S2360).

When the search reference position is thus determined, all the exits of the specified expressway are extracted (S2370). Driving routes with the exits of the specified expressway, extracted at S2370, taken as points of departure and the search reference position, stored in the RAM at S2350 or S2360, taken as objective point are computed (S2380). Further, the lengths of the individual driving routes (distances to drive) are computed (S2390). Then, exits extracted at S2370 are sorted in ascending order of the distances to drive (S2400). Then, based on the result of this sorting, an exit list of the exits and the distances to drive in pairs is displayed on the display unit 25 (S2410).

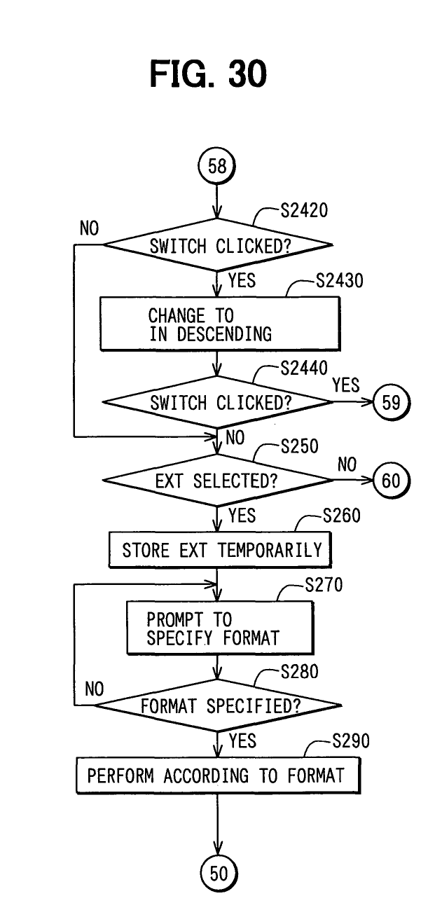

Subsequently, it is determined whether the changeover switch has been clicked, as illustrated in FIG. 30 (S2420). When it is detected that the changeover switch has been clicked (S2420: YES), the display image is changed to an exit list of the exits of the specified expressway in descending order of the distances to drive (S2430). As in the entrance list, when it is detected that the changeover switch has been clicked again (S2440: YES), the operation goes back to S2400. Thus, the user can turn the display image back to the exit list in ascending order of the distances to drive.

Thereafter, the operation waits until any exit is selected through the operating switch group 22 or the remote controller 27. Then, the operation further waits until a storing format therefor is specified, and processing is performed according to the specified storing format (S250 to S290).

As described above, according to the fifth embodiment, a user can switch between the exist list in ascending order of the distances to drive from the present position or a specified search reference position and the exit list in descending order thereof. As a result, when the user is going to get of f an expressway as soon as possible, the user can display an exit list in ascending order of the distances to drive. When the user desires to enjoy driving on an expressway as long as possible, the user can display an exit list in descending order of the distances to drive.

According to the fifth embodiment, a user can also switch between the entrance list in ascending order of the distances to drive and the entrance list in descending order thereof. Thus, when a user is going to enjoy driving on local roads at a tourist resort or the like as long as possible and then go home by expressway, the user is provided with useful information.

(Sixth Embodiment)

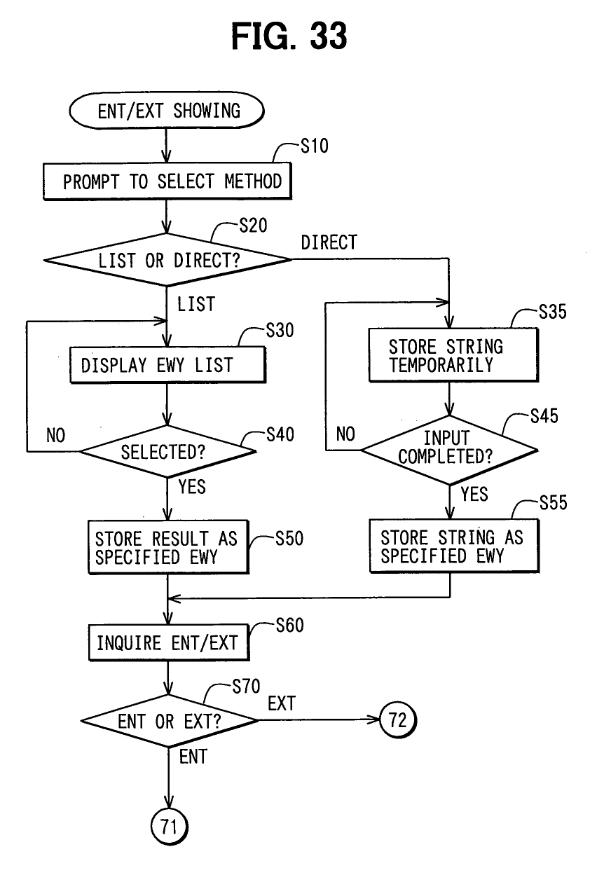

Next, a sixth embodiment will be described. The constitution of the device in the sixth embodiment is also the same as in the first embodiment. In the sixth embodiment, processing for showing the entrances and exits of an expressway is performed based on a computer program which follows the procedure illustrated in FIG. 33 to FIG. 42. This processing is initiated when the user inputs an actuation signal through the operating switch group 22 or the remote controller 27.

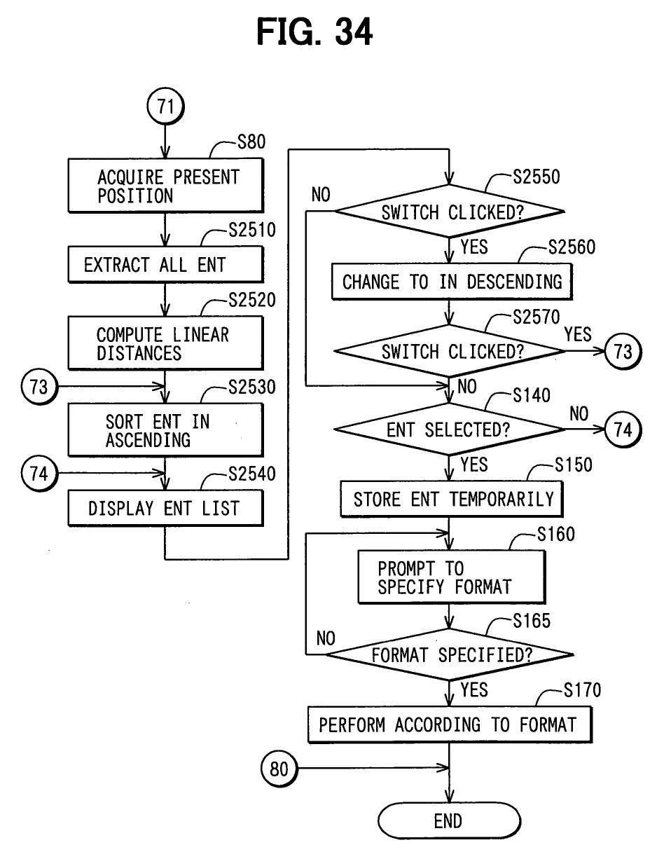

As illustrated in FIG. 33 to FIG. 42, the processing for showing the entrances and exits of an expressway, performed in the sixth embodiment, is substantially the same as in the first embodiment. Therefore, the same step numbers will be assigned to the same processing steps as in the first embodiment. The detailed description thereof will be omitted. In the sixth embodiment, the user operates the operating switch group 22 or the remote controller 27 to determine a specified expressway and select the display of entrances (S10 to S70). When that is detected, the present position is acquired from the position sensor 10, as illustrated in FIG. 34 (S80). Further, all the entrances of the specified expressway are extracted (S2510).

Subsequently, the linear distances between the present position acquired at S80 and all the entrances of the specified expressway extracted at S2510 are computed (S2520). Then, the entrances of the specified expressway are sorted in ascending order of the linear distances computed at S2520 (S2530). A list based on the result of this sorting is displayed on the display unit 25 (S2540). In the list, the entrances of the specified expressway and the linear distances computed at S2520 are listed in pairs in ascending order of the linear distances.

When the entrance list in ascending order of the linear distances is displayed, it is determined whether a changeover switch for changing the display image to a list in descending order of the linear distances has been clicked (S2550). If it is detected that the changeover switch has been clicked (S2550: YES), the display image is changed to an entrance list of the entrances of the specified expressway in descending order of the linear distances (S2560). If, with the list in ascending order of the linear distances on display, it is detected that the changeover switch has been clicked (S2570: YES), the operation goes back to S2530. Thus, the user can turn the display image back to the entrance list in ascending order of the linear distances.

Thereafter, the operation waits until any entrance is selected through the operating switch group 22 or the remote controller 27. Then, the operation further waits until a storing format therefor is specified, and processing is performed according to the specified storing format (S140 to S170).

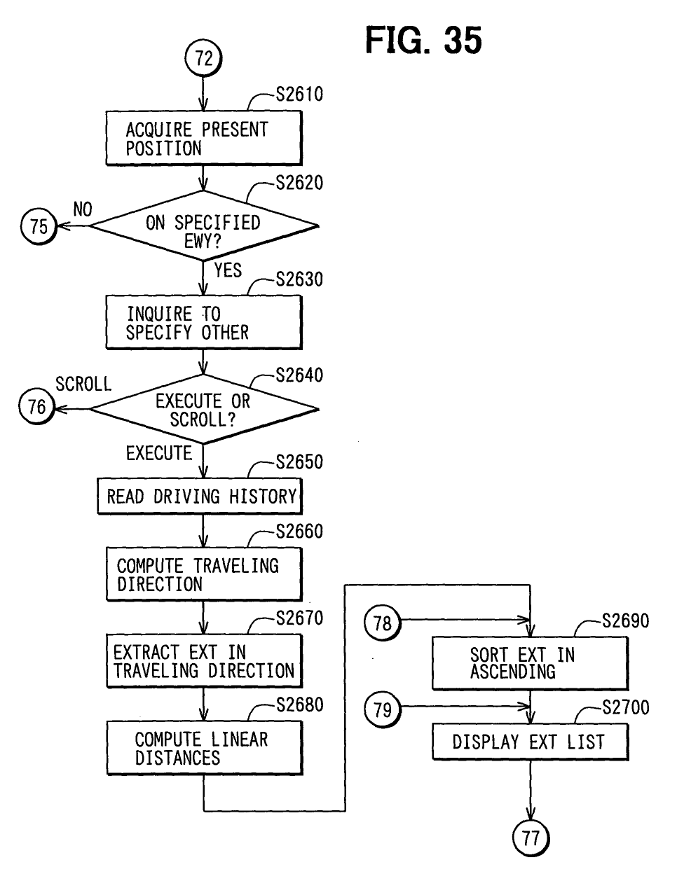

Alternatively, the user may operate the operating switch group 22 or the remote controller 27 to select exits. When that is detected (S70: Exits), the present position of the vehicle is acquired from the position sensor 10, as illustrated in FIG. 35 (S2610). Then, it is determined whether the present position is on the specified expressway (S2620). If the present position is determined to be on the specified expressway (S2620: YES), a message is displayed on the display unit 25 (S2630). The message is for inquiring whether the present position is used as the search reference position for exit list display.

The user may operate the operating switch group 22 or the remote controller 27 to input “Execute.” When that is detected (S2640: Execute), the driving history is read out of the external memory 24 (S2650). After the driving history is thus read out, the traveling direction is computed from the driving history (S2660). Then, all the exits of the specified expressway, located in the traveling direction relative to the present position, are extracted (S2670). Subsequently, the linear distances between the present position and the individual exits extracted at S2670 are computed (S2680).

Subsequently, the exits extracted at S2670 are sorted in ascending order of the linear distances computed at S2680 (S2690). Based on the result of this sorting, an exit list in ascending order of the linear distances is displayed on the display unit 25 (S2700).

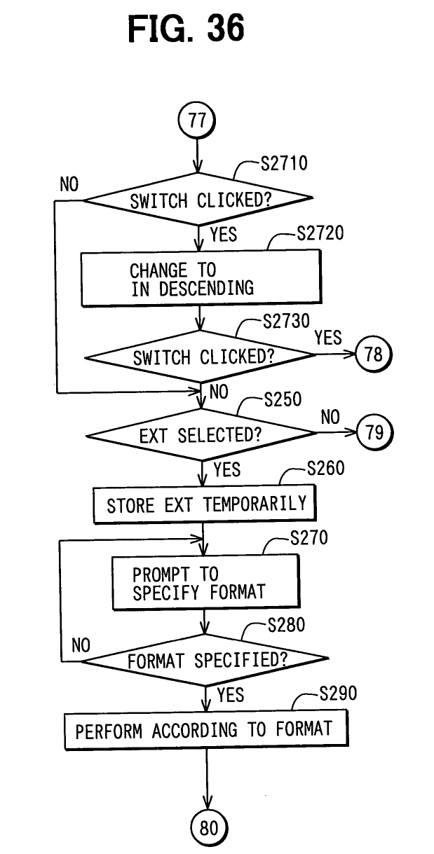

After the display of the exit list is thus completed, it is determined whether the changeover switch has been clicked, as illustrated in FIG. 36 (S2710). When it is detected that the changeover switch has been clicked (S2710: YES), the display image is changed to an exit list of the exits of the specified expressway in descending order of the linear distances (S2720). As in the entrance list, when it is detected that the changeover switch has been clicked again (S2730: YES), the operation goes back to S2690. Thus, the user can turn the display image back to the exit list in ascending order of the linear distances.

Thereafter, the operation waits until any exit is selected through the operating switch group 22 or the remote controller 27. Then, the operation further waits until a storing format therefor is specified, and processing is performed according to the specified storing format (S250 to S290).

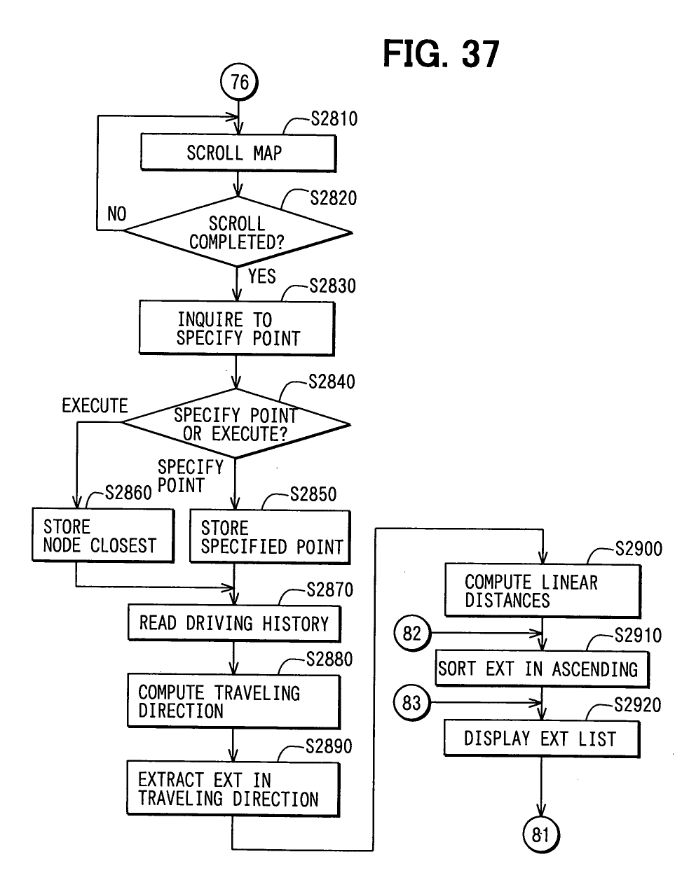

When the present position is on the specified expressway (S2620: YES), the user may specify a position other than the present position as the search reference position for exit list display. To do this, the user operates the operating switch group 22 or the remote controller 27 to provide an instruction to scroll a map (S2640: Scroll). In this case, the map is scrolled according to the instruction to scroll, as illustrated in FIG. 37 (S2810). Thereafter, it is determined whether the instruction to scroll has been terminated (S2820). As long as it is detected that the instruction to scroll is being inputted (S2820: NO), the operation goes back to S2810 and scrolling of the map is continued. When the instruction to scroll is terminated (S2820: YES), a message is displayed on the display unit 25 (S2830). The message is for inquiring whether to specify a point on the presently displayed map as the search reference position.

The user may operate the operating switch group 22 or the remote controller 27 to specify a point on the map or input “Execute.” If the user specifies a point, for example, a service area, on the map (S2840: Specify point), the position coordinates of the specified point are stored in the RAM as the search reference position (S2850). Alternatively, if the user inputs “Execute” (S2840: Execute), the node closest to the center of the presently displayed map is stored in the RAM as the search reference position (S2860).

When the search reference position is thus determined, the driving history is read out of the external memory 24 (S2870). Based on the driving history read out at S2870, the traveling direction is computed (S2880). Then, all the exits of the specified expressway, located in the traveling direction relative to the search reference position determined at S2850 or S2860, are extracted (S2890). Subsequently, the linear distances between the search reference position, determined at S2850 or S2860, taken as point of departure and the exits, extracted at S2890, taken as destinations are computed (S2900).

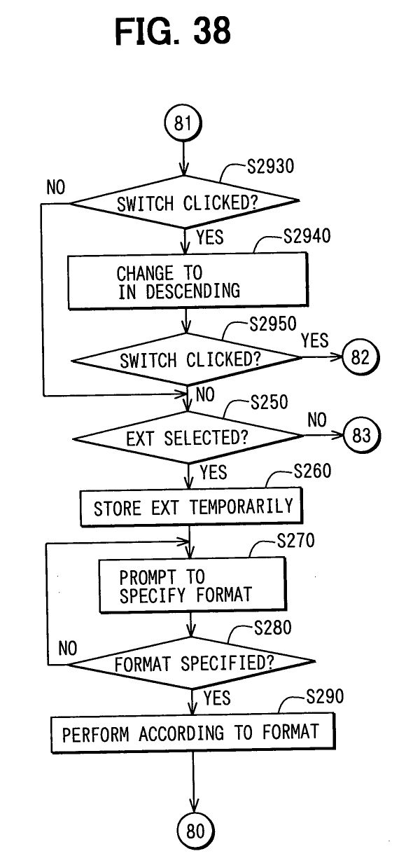

Subsequently, the exits extracted at S2890 are sorted in ascending order of the linear distances (S2910). Based on the result of this sorting, an exit list in ascending order of the linear distances is displayed on the display unit 25 (S2920) After the display of the exit list is thus completed, it is determined whether the changeover switch has been clicked, as illustrated in FIG. 38 (S2930). When it is detected that the changeover switch has been clicked (S2930: YES), the display image is changed to an exit list of the exits of the specified expressway in descending order of the linear distances computed at S2900 (S2940). As in the entrance list, when it is detected that the changeover switch has been clicked again (S2950: YES), the operation goes back to S2910. Thus, the user can turn the display image back to the exit list in ascending order of the linear distances.

Thereafter, the operation waits until any exit is selected through the operating switch group 22 or the remote controller 27. Then, the operation further waits until a storing format therefor is specified, and processing is performed according to the specified storing format (S250 to S290).

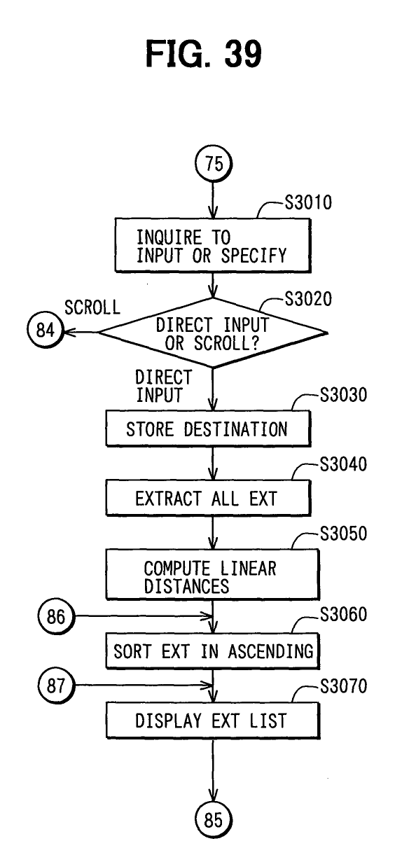

Alternatively, when the present position is not on the specified expressway (S2620: NO), a message is displayed on the display unit 25 (S3010). This message is for inquiring whether to directly input a destination or specify it on a map, as illustrated in FIG. 39. If the user directly inputs a destination by facility name, facility phone number, municipality name, unique location code, or the like (S3020: Direct input), the destination is stored in the RAM (S3030). Further, all the exits of the specified expressway are extracted (S3040).

Subsequently, the linear distances between the individual exits, extracted at S3040, and the destination, stored at S3030, are computed (S3050). Then, the exit extracted at S3040 are sorted in ascending order of the linear distances (S3060). An exit list based on the result of this sorting is displayed on the display unit 25 (S3070). In this exit list, the exits extracted at S3040 and the linear distances computed at S3050 are listed in pairs in ascending order of the linear distances.

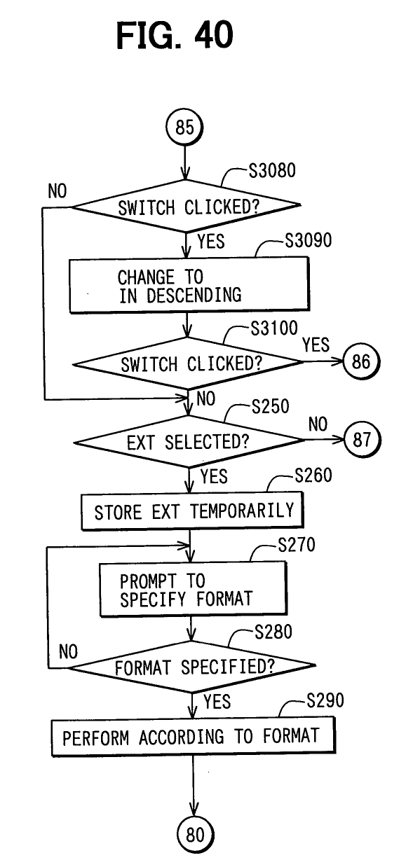

After the display of the exit list is thus completed, it is determined whether the changeover switch has been clicked, as illustrated in FIG. 40 (S3080). When it is detected that the changeover switch has been clicked (S3080: YES), the display image is changed to an exit list of the exits of the specified expressway in descending order of the linear distances (S3090). As in the entrance list, when it is detected that the changeover switch has been clicked again (S3100: YES), the operation goes back to S3060. Thus, the user can turn the display image back to the exit list in ascending order of the linear distances.

Thereafter, the operation waits until any exit is selected through the operating switch group 22 or the remote controller 27. Then, the operation further waits until a storing format therefor is specified, and processing is performed according to the specified storing format (S250 to S290).

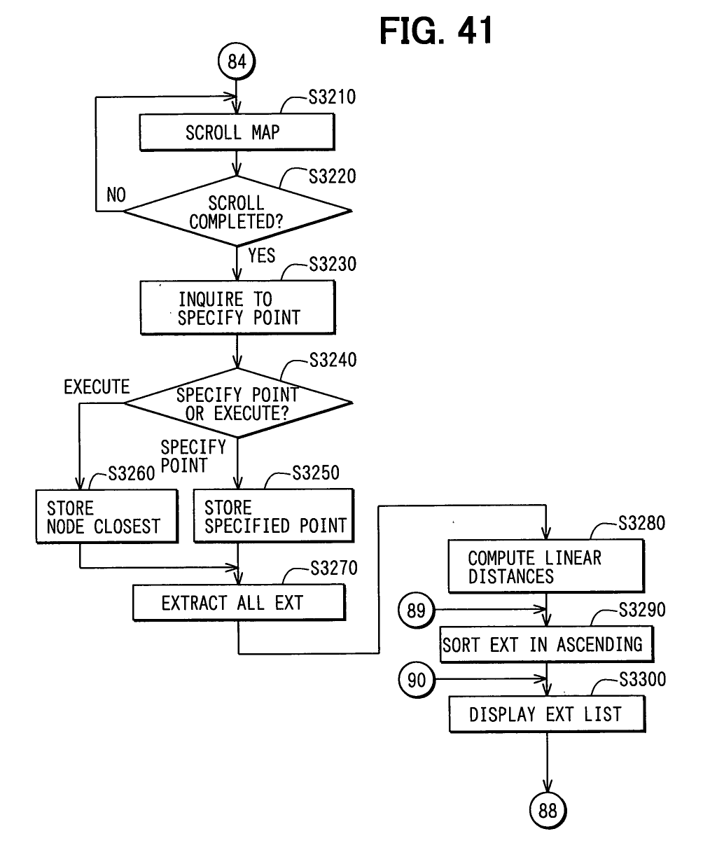

Alternatively, the user may desire to scroll the map to specify a destination on the map. When it is detected that the user has provided an instruction to scroll the map (S3020: Scroll), the map is scrolled according to the instruction to scroll, as illustrated in FIG. 41 (S3210). Thereafter, it is determined whether the instruction to scroll has been terminated (S3220). As long as it is detected that the instruction to scroll is being inputted (S3220: NO), the operation goes back to S3210 and scrolling of the map is continued. When it is detected that the instruction to scroll has been terminated (S3220: YES), a message is displayed on the display unit 25 (S3230). The message is for inquiring whether to specify a point on the presently displayed map as the search reference position.

In this state, the user may operate the operating switch group 22 or the remote controller 27 to specify a point on the map or input “Execute.” If it is detected that the user has specified a point on the map (S3240: Specify point), the position coordinates of the specified point are stored in the RAM as the search reference position (S3250). Alternatively, if it is detected that the user has inputted “Execute” (S3240: Execute), the node closest to the center of the presently displayed map is stored in the RAM as the search reference position (S3260).

When the search reference position is thus determined, all the exits of the specified expressway are extracted (S3270). The linear distance between the exits of the specified expressway, extracted at S3270, and the search reference position, stored in the RAM at S3250 or S3260, are computed (S3280). Then, the exits extracted at S3270 are sorted in ascending order of the linear distances (S3290). Based on the result of this sorting, an exit list of the exits and the linear distances in pairs is displayed on the display unit 25 (S3300).

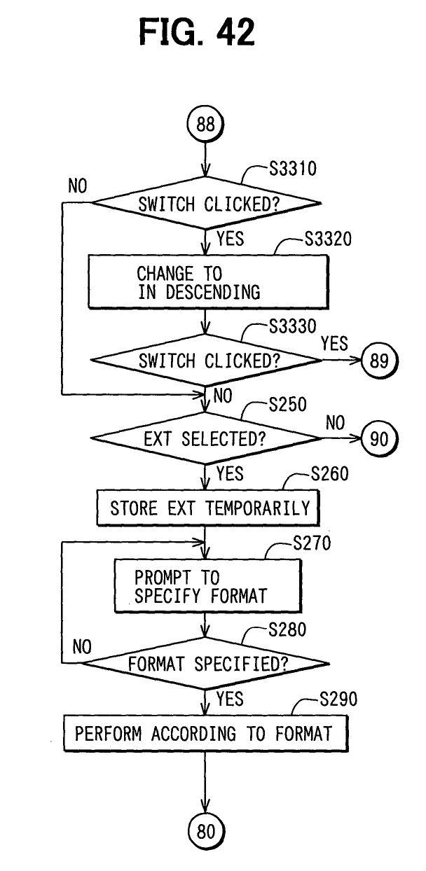

Subsequently, it is determined whether the changeover switch has been clicked, as illustrated in FIG. 42 (S3310). When it is detected that the changeover switch has been clicked (S3310: YES), the display image is changed to an exit list of the exits of the specified expressway in descending order of the linear distances (S3320). As in the entrance list, when it is detected that the changeover switch has been clicked again (S3330: YES), the operation goes back to S3290. Thus, the user can turn the display image back to the exit list in ascending order of the linear distances.

Thereafter, the operation waits until any exit is selected through the operating switch group 22 or the remote controller 27. Then, the operation further waits until a storing format therefor is specified, and processing is performed according to the specified storing format (S250 to S290).

As described above, according to the sixth embodiment, a user can switch between the exit list in ascending order of the linear distances from the present position or a specified search reference position and the exit list in descending order thereof. As a result, when the user is going to get off an expressway as soon as possible, the user can display an exit list in ascending order of the linear distances. When the user desires to enjoy driving on an expressway as long as possible, the user can display an exit list in descending order of the linear distances.

(Other Modification)

Up to this point, some embodiments of the present invention have been described. However, the present invention is not limited to these embodiments. Naturally, more varied embodiments can be adopted to the extent that the subject matter of the present invention is not exceeded.

For example, the present invention can be applied to a navigation device for searching the entrances and exits of roads with entrances and exits fixed other than expressways. Such roads include freeways, toll roads, cycling roads, and walks. Therefore, the navigation device of the present invention can be constituted as a portable device as well as in-vehicle device.

Further, driving times required to drive to entrances or exits may be used, instead of the lengths of driving routes to the entrances or exits. This is because the length of a driving route in general corresponds to the driving time therefor. Thus, an entrance list or exit list in ascending order of the driving times may be displayed.

Alternatively, distances to drive need not be displayed in an entrance list or exit list. Further, times required to get to entrances or exits, times required to drive from exits to a destination, or the like may be displayed in an entrance list or exit list, instead of distances to drive.

Further, required driving time may be computed without taking information from VICS into account. Information acquired from any other advanced road transportation system than VICS may be utilized in route computation. Such road transportation systems include ATIS (Advanced Traffic Information Service: members-only traffic information service provided mainly in Tokyo), RDSTMC (Radio Data System—Traffic Message Channel: traffic information service common in Europe), and ITS (Intelligent Transport Systems: intelligent road transportation systems pushed ahead with in Japan and in Europe and the United States). In such cases, driving times required to drive from a search reference position to the entrances of an expressway, or driving times required to drive from the exits of an expressway to a destination may be computed. Then, an entrance list or exit list in ascending order of these required driving times may be displayed. Further, in addition to driving times, information on toll booths acquired from ETC (Electronic Toll Collection system) may be taken into account. Then, when an entrance list or exit list is generated, presence/absence of a toll gate for ETC may be taken into account in sorting.

It will be obvious to those skilled in the art that various changes may be made in the above-described embodiments of the present invention. However, the scope of the present invention should be determined by the following claims.

What is claimed is:

1. A navigation device including:
a display unit;
a map data input unit for inputting map data, wherein the map data contains information on a plurality of roads with entrances and exits, such as expressways and toll roads; and
a display control unit for displaying the map data inputted from the map data input unit on the display unit, the navigation device comprising:
a road specifying unit for specifying a certain road from the plurality of roads;
a search reference position determining unit for determining a search reference position; and
an entrance list display control unit for sorting entrances to the certain road specified by the road specifying unit in a sequence on a basis of the search reference position determined by the search reference position determining unit and for listing the sorted entrances in the sequence as an entrance list on the display unit.

2. The navigation device according to claim 1,
wherein the entrance list display control unit includes an entrance extracting unit that extracts all entrances to the certain road specified by the road specifying unit, and
wherein the entrance list display control unit sorts all the entrances extracted by the entrance extracting unit.

3. The navigation device according to claim 1,
wherein the entrance list display control unit includes an entrance extracting unit for extracting entrances meeting condition on the basis of the search reference position from all entrances to the certain road specified by the road specifying unit, and
wherein the entrance list display control unit sorts the entrances extracted by the entrance extracting unit.

4. The navigation device according to claim 1,
wherein the entrance list display control unit includes a driving route determining unit that determines driving routes between the search reference position and respective entrances to the certain road, and
wherein the entrance list display control unit sorts the entrances to the certain road based on driving times required for driving down the driving routes determined by the driving route determining unit.

5. The navigation device according to claim 4,
wherein the entrance list display control unit sorts the entrances to the certain road in ascending order of the driving times.

6. The navigation device according to claim 4,
wherein the entrance list display control unit lists, in pairs in the entrance list, the sorted entrances and the driving times, which correspond to the sorted entrances, respectively.

7. The navigation device according to claim 1,
wherein the entrance list display control unit includes a driving route determining unit that determines driving routes between the search reference position and respective entrances to the certain road, and
wherein the entrance list display control unit sorts the entrances to the certain road based on lengths of driving routes determined by the driving route determining unit.

8. The navigation device according to claim 7,
wherein the entrance list display control unit sorts the entrances to the certain road in ascending order of the lengths of the driving routes.

9. The navigation device according to claim 7,
wherein the entrance list display control unit lists, in pairs in the entrance list, the sorted entrances and the lengths of the driving routes, which correspond to the sorted entrances, respectively.

10. The navigation device according to claim 1,
wherein the entrance list display control unit sorts the entrances to the certain road based on linear distances between the search reference position and the respective entrances.

11. The navigation device according to claim 10,
wherein the entrance list display control unit sorts the entrances to the certain road in ascending order of the linear distances.

12. The navigation device according to claim 10,
wherein the entrance list display control unit lists, in pairs in the entrance list, the sorted entrances and the linear distances, which correspond to the sorted entrances, respectively.

13. The navigation device according to claim 1, further comprising:
a present position detecting unit for detecting a present position, wherein the search reference position determining unit identifies the present position detected by the present position detecting unit as the search reference position.

14. The navigation device according to claim 1, further comprising:
a position specifying unit for specifying a position on the map data, wherein the search reference position determining unit identifies the position specified by the position specifying unit as the search reference position.

15. The navigation device according to claim 1, further comprising:
a scrolling unit for scrolling a map displayed on the display unit, wherein the search reference position determining unit identifies, as the search reference position, a given position on a map that is displayed on the display unit after being scrolled by the scrolling unit.

16. The navigation device according to claim 1,
wherein the entrance list display control unit includes a display switching unit for switching the sequence of entrances in the entrance list to an appellative sequence.

17. The navigation device according to claim 1, further comprising:
an entrance selecting unit for selecting an entrance from the entrance list; and
a selected entrance storing unit for storing the entrance selected by the entrance selecting unit.

18. A navigation device including:
a display unit;
a map data input unit for inputting map data, wherein the map data contains information on a plurality of roads with entrances and exits, such as expressways and toll roads; and
a display control unit for displaying the map data inputted from the map data input unit on the display unit, the navigation device comprising:
a road specifying unit for specifying a certain road from the plurality of roads;
a search reference position determining unit for determining a search reference position; and
an exit list display control unit for sorting exits from the certain road specified by the road specifying unit in a sequence on a basis of the search reference position determined by the search reference position determining unit and for listing the sorted exits in the sequence as an exit list on the display unit.

19. The navigation device according to claim 18,
wherein the exit list display control unit includes an exit extracting unit that extracts all exits from the certain road specified by the road specifying unit, and
wherein the exit list display control unit sorts all the exits extracted by the exit extracting unit.

20. The navigation device according to claim 18,
wherein the exit list display control unit includes an exit extracting unit for extracting exits meeting condition on the basis of the search reference position from all exits from the certain road specified by the road specifying unit, and
wherein the exit list display control unit sorts the exits extracted by the exit extracting unit.

21. The navigation device according to claim 18,
wherein the exit list display control unit includes a driving route determining unit that determines driving routes between the search reference position and respective exits from the certain road, and
wherein the exit list display control unit sorts the exits from the certain road based on driving times required for driving down the driving routes determined by the driving route determining unit.

22. The navigation device according to claim 21,
wherein the exit list display control unit sorts the exits from the certain road in ascending order of the driving times.

23. The navigation device according to claim 21,
wherein the exit list display control unit sorts the exits from the certain road in descending order of the driving times.

24. The navigation device according to claim 21,
wherein the exit list display control unit lists, in pairs in the exit list, the sorted entrances and the driving times, which correspond to the sorted entrances, respectively.

25. The navigation device according to claim 18,
wherein the exit list display control unit includes a driving route determining unit that determines driving routes between the search reference position and respective exits from the certain road, and
wherein the exit list display control unit sorts the exits from the certain road based on lengths of driving routes determined by the driving route determining unit.

26. The navigation device according to claim 25,
wherein the exit list display control unit sorts the exits from the certain road in ascending order of the lengths of the driving routes.

27. The navigation device according to claim 25,
wherein the exit list display control unit sorts the exits from the certain road in descending order of the lengths of the driving routes.

28. The navigation device according to claim 25,
wherein the exit list display control unit lists, in pairs in the exit list, the sorted entrances and the lengths of the driving routes, which correspond to the sorted entrances, respectively.

29. The navigation device according to claim 18,
wherein the exit list display control unit sorts the exits from the certain road based on linear distances between the search reference position and the respective exits.

30. The navigation device according to claim 29,
wherein the exit list display control unit sorts the exits from the certain road in ascending order of the linear distances.

31. The navigation device according to claim 29,
wherein the exit list display control unit sorts the exits from the certain road in descending order of the linear distances.

32. The navigation device according to claim 29,
wherein the exit list display control unit lists, in pairs in the exit list, the sorted entrances and the linear distances, which correspond to the sorted entrances, respectively.

33. The navigation device according to claim 18, further comprising:
a present position detecting unit for detecting a present position, wherein the search reference position determining unit identifies the present position detected by the present position detecting unit as the search reference position.

34. The navigation device according to claim 18, further comprising:
a position specifying unit for specifying a position on the map data, wherein the search reference position determining unit identifies the position specified by the position specifying unit as the search reference position.

35. The navigation device according to claim 18, further comprising:
a scrolling unit for scrolling a map displayed on the display unit, wherein the search reference position determining unit identifies, as the search reference position, a given position on a map that is displayed on the display unit after being scrolled by the scrolling unit.

36. The navigation device according to claim 18,
wherein the exit list display control unit includes a display switching unit for switching the sequence of exits in the exit list to an appellative sequence.

37. The navigation device according to claim 18, further comprising:
an exit selecting unit for selecting an exit from the exit list; and
a selected exit storing unit for storing the exit selected by the exit selecting unit.

38. A sorting and listing method used in a navigation device that includes:
a display unit;
a map data input unit for inputting map data, wherein the map data contains information on a plurality of roads with entrances and exits, such as expressways and toll roads; and
a display control unit for displaying the map data inputted from the map data input unit on the display unit, the method comprising steps:
specifying a certain road from the plurality of roads;
determining a search reference position; and
sorting and listing, in the display unit, one set of a first and second sets, wherein the first set includes entrances to the specified certain road and the second set includes exits from the specified certain road, in a sequence on a basis of the determined search reference position.
